(19) United States
(12) Patent Application Publication
(10) Pub. No.: US 2026/0289135 A1
(43) Pub. Date: Sep. 24, 2026

(54) SYSTEM

(71) Applicant: SoftBank Group Corp., Tokyo (JP)

(72) Inventor: Keiichi TAKAGI, Tokyo (JP)

(73) Assignee: SoftBank Group Corp., Tokyo (JP)

(21) Appl. No.: 19/562,887

(22) Filed: Mar. 11, 2026

(30) Foreign Application Priority Data
Mar. 19, 2025 (JP) 2025-044500

(51) Int. Cl. G06F 40/30; G06N 3/045

(52) U.S. Cl. CPC G06F 40/30; G06N 3/045

(57) ABSTRACT

A system includes a processor that is configured to receive an inquiry from a user, analyze the received inquiry and generate a prompt for instructing a generative AI model to generate a solution to the inquiry, and present the generated solution to the user.

### CROSS-REFERENCE TO RELATED APPLICATION

This application is based on and claims priority under 35 USC 119 from Japanese Patent Application No. 2025-044500 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information provision systems and search tools generally return uniform answers that are not sufficiently tailored to the specific context, behavior history, or preferences of an individual user. Even when generative AI models are employed, the input to such models is often limited to the literal text of the user's current inquiry, resulting in solutions that may be generic, impersonal, or not optimally aligned with the user's needs. Furthermore, existing systems do not adequately integrate a user's past usage history of information search tools or location information into the prompt design for generative AI models, and therefore fail to fully leverage available contextual data to enhance solution relevance. In addition, many systems lack a mechanism for systematically adjusting prompts so that the generative AI model can propose personalized solutions based on the user's past behavior history and preferences. Accordingly, there is a need for a system that can receive a user's inquiry, generate an appropriate prompt for a generative AI model by incorporating user-specific contextual information, and present a more relevant and personalized solution to the user.

### SUMMARY

In order to solve the above-described problems, according to one aspect of the present invention, there is provided a system comprising a processor, wherein the processor is configured to receive an inquiry from a user, analyze the received inquiry, and generate a prompt for instructing a generative AI model to generate a solution to the inquiry. The processor is further configured to present the solution generated by the generative AI model to the user. The processor may acquire at least one of a past usage history of an information search tool of the user and location information of the user, and use the acquired information as additional information for generating the prompt, thereby enabling the generative AI model to take into account contextual and environmental factors related to the user. Moreover, the processor may adjust the prompt so that the generative AI model proposes a personalized solution based on at least one of a past behavior history of the user and a preference of the user, thereby allowing the system to output solutions that are customized to the individual user's habits, interests, and goals. By these means, the system can generate and provide solutions that are both context-aware and personalized, improving the relevance and practical usefulness of the answers delivered to the user.

The term “system” refers to an arrangement of hardware and/or software components that cooperatively perform processing, communication, and control operations to implement the functions described in the claims.

The term “processor” refers to any hardware logic device or combination of devices, including but not limited to a CPU, GPU, ASIC, FPGA, or microcontroller, capable of executing instructions and performing arithmetic, logic, and control operations.

The term “user” refers to any human operator or entity that interacts with the system by providing inquiries and receiving solutions.

The term “inquiry” refers to any information request, question, problem statement, or command input by the user and transmitted to the system for processing.

The term “generative AI model” refers to a machine learning model, such as a neural network, configured to generate text, images, or other content in response to an input prompt, and in particular to generate solutions or answers to user inquiries.

The term “solution” refers to any answer, recommendation, guidance, plan, or other output generated by the generative AI model in response to a user's inquiry.

The term “prompt” refers to data, including text and optionally structured metadata, that is generated by the processor and provided as input to the generative AI model to instruct the generative AI model regarding the content, style, or constraints of the solution to be generated.

The term “information search tool” refers to any software or service that allows the user to search for information, including but not limited to web browsers, search engines, in-application search functions, or dedicated search applications.

The term “past usage history of an information search tool” refers to stored data representing the user's previous interactions with an information search tool, including search queries, accessed resources, timestamps, and related metadata.

The term “location information” refers to data indicating a geographic position associated with the user or the user's terminal, including but not limited to GPS coordinates, network-based location data, or other forms of geolocation data.

The term “additional information for generating the prompt” refers to contextual data, such as past usage history or location information, that is used by the processor in combination with the current inquiry to form or modify the prompt supplied to the generative AI model.

The term “past behavior history of the user” refers to data representing actions previously taken by the user in relation to the system or other services, including past inquiries, selected solutions, interaction patterns, and usage frequency.

The term “preference of the user” refers to any explicit or implicit indication of the user's likes, dislikes, interests, constraints, or goals, derived from user input or inferred from the user's past behavior history.

The term “personalized solution” refers to a solution that is tailored or adapted to a specific user based on at least one of the user's past behavior history and the user's preferences, rather than being a generic solution that is the same for all users.

The term “adjust the prompt” refers to modifying, augmenting, or re-structuring the content or parameters of the prompt generated by the processor so that the generative AI model produces a solution that is more context-aware or personalized for the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

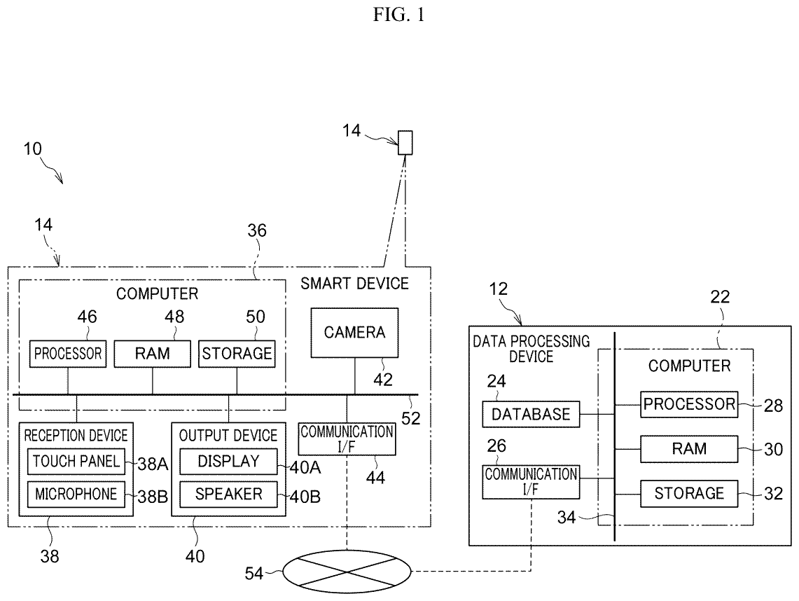

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

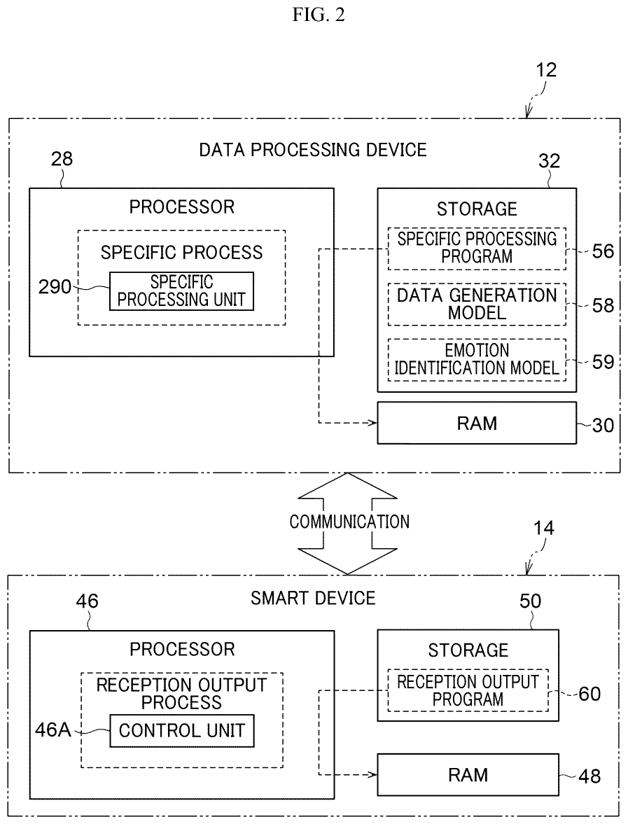

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented information retrieval systems that provide answers to user inquiries generally rely on static rule-based processing, fixed search templates, or direct keyword matching against data resources. Such systems typically treat natural language input, user context, and backend data schemas as separate concerns and do not dynamically integrate them in a unified computational flow. As a result, these systems often fail to generate queries and responses that are appropriately tailored to the user's actual intent and real-time context, especially when the user's location or behavior history is relevant.

In particular, when a user issues a free-form natural language inquiry such as a request for the nearest facility or a service suitable for a specific situation, conventional systems require substantial manual engineering to design query logic, and they often cannot adapt the query design at runtime. The server-side software lacks a mechanism to algorithmically synthesize machine-executable search or processing conditions from the user's intent, the user's location, and the structure of the underlying information resources. Furthermore, even where so-called generative AI models are employed, they are often used only to generate human-readable answers, without tightly coupling their output to the formation of backend query conditions or to the structured post-processing of search results.

As a consequence, existing systems exhibit several technical deficiencies: server resources are used inefficiently because of suboptimal or redundant queries; the quality and precision of retrieved results are limited due to coarse or manually fixed filters; and additional computation is required on the terminal side to interpret or refine the returned results. Moreover, conventional systems do not provide a systematic server-side mechanism to incorporate geospatial computation-such as distance-based ranking-into the data pipeline in a manner that is visible and exploitable by the generative AI model. This leads to inaccurate or non-personalized recommendations when location-dependent information is required. There is therefore a need for an improved computer-implemented technique in which a server automatically generates machine-oriented prompt sentences for a generative AI model based on user inquiries, real-time location information, and attributes of organizational information resources, obtains structured search or processing conditions from the generative AI model, and transforms these conditions into concrete queries and post-processing steps. Such a technique should also allow the server to compute geospatial metrics on candidate results, encode the results as structured data, and feed them back to the generative AI model so that the model can generate location-dependent personalized solution information. By reorganizing these operations into a coherent processing pipeline executed by the server, the overall functioning of the computer system can be improved in terms of relevance, efficiency, and adaptability of responses to user inquiries.

The specific processing by the specific processing unit 290 of the data processing device 12 in Example 1 is realized by the following means.

The present invention provides a server comprising a processor configured to receive user information including inquiry information and location information from a terminal operated by a user; analyze the received user information to determine an intention of the inquiry information; generate a prompt sentence including the determined intention, the location information, and attribute information of information resources of an organization group, the prompt sentence being configured to instruct a generative AI model to generate search conditions or processing conditions; output the prompt sentence to the generative AI model and acquire, from the generative AI model, the search conditions or the processing conditions in a structured form; generate query data for searching the information resources of the organization group based on the acquired search conditions or the processing conditions; search the information resources using the query data and acquire candidate information; perform a computation on the candidate information using geospatial information stored in an information processing apparatus or an information management apparatus having a geographic information processing function, the computation being based on distance information; generate structured data reflecting a result of the computation; generate a further prompt sentence including at least part of the candidate information and the structured data to instruct the generative AI model to summarize or rank the candidate information; acquire, from the generative AI model, personalized solution information generated in accordance with the further prompt sentence; and transmit the acquired personalized solution information to the terminal of the user and cause the terminal to present the personalized solution information. This enables the server to technically improve the overall information processing pipeline by programmatically translating free-form user inquiries and contextual signals into machine-executable search and geospatial computation workflows, by leveraging the generative AI model not merely for natural language output but as a dynamic generator of search and processing conditions, thereby enhancing the efficiency, precision, and personalization of location-dependent responses in a computer-implemented information retrieval environment.

The term “user information” refers to data associated with a user, including at least inquiry information and location information, and optionally including identifiers, timestamps, and behavior history information.

The term “inquiry information” refers to content representing a request or question from a user, typically expressed in natural language and indicating an information need, an action request, or a desired recommendation.

The term “location information” refers to data indicating a geographic position of a user or a terminal, including, for example, coordinates such as latitude and longitude or other geospatial identifiers.

The term “terminal” refers to an information processing device operated by a user, such as a computing device, a communication device, or a display device, that is configured to transmit user information to a server and present information received from the server.

The term “processor” refers to a hardware or virtual processing unit, such as a central processing unit or an execution core, configured to execute instructions for performing the functions of the server described in the present disclosure.

The term “intention” refers to a semantic representation of what a user intends to achieve by an inquiry, including, for example, a requested task type, a target entity type, or a desired operation to be performed on information resources.

The term “organization group” refers to a plurality of related entities, such as service providers or resource holders, that collectively manage or provide access to information resources under a common framework or relationship.

The term “information resources” refers to data sets or data collections managed by or associated with an organization group, including, for example, records stored in databases, data repositories, or information management systems.

The term “attribute information” refers to metadata or structural data describing properties of information resources, including, for example, field names, data types, categories, or schema-related information.

The term “prompt sentence” refers to a sequence of machine-readable characters or tokens, typically in natural language or a structured format, configured to be provided as input to a generative AI model in order to instruct the generative AI model to perform a specific processing task.

The term “generative AI model” refers to a machine learning model configured to generate output data such as text or structured data in response to an input prompt sentence, based on learned parameters, and to produce search conditions, processing conditions, summaries, or recommendations.

The term “search conditions” refers to constraints, filters, or selection criteria generated by the generative AI model or by the processor, which specify how information resources are to be searched or filtered.

The term “processing conditions” refers to instructions or parameters specifying how data operations are to be performed on information resources or candidate information, including, for example, sorting, ranking, aggregation, or transformation rules.

The term “query data” refers to machine-executable data expressing a request to retrieve or manipulate information resources, such as a database query, an application programming interface request, or a search expression.

The term “candidate information” refers to result data obtained by applying query data to information resources, the result data representing a set of items, records, or entities that potentially satisfy the user's inquiry.

The term “support information” refers to auxiliary data used to enhance processing by the server, including at least location information and behavior history information, and optionally other contextual information related to a user or a terminal.

The term “behavior history information” refers to data representing past actions, usage patterns, or interactions of a user with a system, an application, or information resources, including, for example, past search queries, selections, or access logs.

The term “geospatial information” refers to data associated with geographic positions or spatial relationships, including coordinates, maps, spatial indexes, and other information used for geographic information processing.

The term “information processing apparatus” refers to a computing device or system configured to process data, including performing computations, executing programs, or storing and retrieving information resources or geospatial information.

The term “information management apparatus” refers to a device or system configured to manage, store, or control access to information resources or geospatial information, such as a database server or a data management system.

The term “geographic information processing function” refers to a capability of an apparatus or system to process geospatial information, including computing distances, performing spatial queries, or evaluating spatial relationships.

The term “distance information” refers to data representing a measure of spatial separation between locations, such as a numerical value indicating a distance between a user's location and a resource location.

The term “structured data” refers to data organized according to a defined format or schema, such as key-value pairs, tables, or hierarchical structures, enabling deterministic parsing and processing by a computer.

The term “personalized solution information” refers to information generated or selected in consideration of user-specific factors, including at least the user's intention and location information, and optionally behavior history information, and presented as a response adapted to the individual user.

The term “response content” refers to data generated for presentation to a user as an answer or recommendation, including natural language text, structured data, or a combination thereof, derived from processing by the server and the generative AI model.

In one embodiment, the server, the terminal, and the user cooperate to implement the invention using a combination of hardware and software components that execute the claimed functions in a concrete, technical manner.

The server uses one or more computing devices such as rack-mounted servers or virtual machines. The server hardware includes at least a central processing unit, a main memory, a non-volatile storage device, and a network interface. In one example, the server uses a multi-core x86-compatible processor, a volatile memory such as DRAM, a persistent storage device such as a solid-state drive, and a network interface controller connected to an IP network. The server runs an operating system such as a general-purpose server operating system and executes server-side software implemented using application frameworks such as a web application framework or an API framework. The server further communicates with an external generative AI model over a network via an application programming interface and communicates with one or more data management systems, such as a relational database management system and a geospatial database extension.

The terminal uses a computing device operated by the user, such as a smartphone, a tablet, or a personal computer. The terminal hardware includes at least a processor, a memory, a display device, an input device, a wireless or wired communication interface, and optionally a positioning module such as a Global Positioning System receiver or a location sensor. The terminal runs an operating system such as a mobile operating system or a desktop operating system and executes a communication application, which may be implemented as a native application or a web application executed by a browser. The communication application provides a user interface including a text input area, a display area, and UI controls for sending and receiving messages.

The user operates the terminal to input inquiry information, to grant or deny permission for location information acquisition, and to review and utilize personalized solution information.

The server executes a software program that includes at least four main logical modules: a user information acquisition module, a prompt sentence generation module, a search and computation module, and a solution presentation module. Each module uses specific data structures and algorithms to process data beyond mere human mental steps.

The server uses the user information acquisition module to obtain user information from the terminal. The user information acquisition module receives, via a network interface, request messages transmitted from the communication application on the terminal. Each request message is represented as a structured data object in memory, such as a key-value record or a message object, containing at least inquiry information, location information, and, optionally, identifiers and behavior history information. The server stores the user information in a storage unit such as a relational database, where a table structure is defined with columns for a user identifier, an inquiry text, a timestamp, latitude, longitude, and additional context. By storing the user information in normalized data structures, the server can perform indexing and efficient retrieval based on user identifiers and timestamps, thereby improving data management performance.

The server uses the prompt sentence generation module to transform the user information into a machine-oriented prompt sentence for a generative AI model. In one embodiment, the server maintains a template repository in memory or storage, where each template is associated with an intent type and a data schema of information resources. The server uses an intent classification component, which may be implemented as a trained neural network or a statistical classifier, to map the inquiry information to one or more intent labels such as “location-based search,” “facility recommendation,” or “emergency support.” The server represents the intent as an internal label stored in memory.

The server then retrieves, from the template repository, a corresponding template structure including placeholders for an intent phrase, coordinates, and attribute information of information resources. The server uses a string assembly algorithm to substitute placeholders in the template with concrete values derived from the user information and metadata about the information resources. For example, the server generates a prompt sentence such as:

“You are a generative AI model that designs location-based search logic.

The user asked: ‘Please tell me the nearest restaurant.’

The user's current location is latitude 35.681236, longitude 139.767125.

The organization group provides a database with fields: id, name, category, latitude, longitude, opening_hours.

Create conditions and sorting logic to find the nearest restaurant that is currently open.

Return your answer as a short explanation followed by JSON-like filters and sort criteria in plain text.”

The server thus encodes, in the prompt sentence, not only the natural language inquiry but also the schema of information resources and an explicit requirement to generate search conditions or processing conditions. The server uses text concatenation and token-length control algorithms to ensure that the prompt sentence does not exceed a predetermined token limit enforced by the generative AI model API. This concrete handling of prompt length avoids truncated requests and reduces network retransmissions, thus improving communication efficiency.

The server uses a generative AI model implemented as a transformer-based neural network. The generative AI model may be deployed on a remote computing platform and is accessible via an API using a secure network protocol. The generative AI model has a multi-layer self-attention architecture, where each layer computes attention scores over token sequences, normalizes the scores, and applies feedforward transformations with non-linear activation functions. The generative AI model stores learned parameters as weight matrices and bias vectors. The generative AI model has been trained in advance using supervised and unsupervised learning methods on large corpora of text and structured data, and further fine-tuned using reinforcement learning from human feedback or task-specific annotated data.

During training, the generative AI model minimizes a loss function such as a cross-entropy loss between predicted token distributions and ground-truth token sequences. A gradient-based optimization algorithm such as stochastic gradient descent or Adam is used to update the weights. The training procedure uses backpropagation through time, mini-batch processing, and data augmentation such as noise injection and paraphrasing to improve robustness. The feature representation includes contextual embeddings of tokens, positional encodings, and learned key, query, and value vectors. The training pipeline and architecture are designed to allow the generative AI model to output not only natural language descriptions but also regular patterns corresponding to structured search and processing conditions.

The server calls the generative AI model by sending the prompt sentence as part of an API request message. The server specifies parameters such as a maximum output token count and a randomness parameter (temperature). The generative AI model returns an output sequence that includes, in a predetermined format, at least an explanation and structured search conditions or processing conditions. For example, for a restaurant search, the generative AI model may return:

“Explanation: To find the nearest restaurant that is currently open, filter records where category is ‘restaurant’ and current time is within opening_hours, then sort by distance from the user's coordinates in ascending order.

Filters: category=‘restaurant’, open_now =true

Sort: by distance ascending”

The server uses the search and computation module to convert the output of the generative AI model into machine-executable query data. The server parses the filters and sort criteria as tokens, maps them to database column names, and constructs a query plan. In one embodiment, the server constructs a relational query that uses a geospatial extension of the database, such as a function for computing distances on a spherical coordinate system. The server binds the location information from the user as runtime parameters. Because the search conditions are generated in a structured form by the generative AI model based on knowledge of the schema, the server avoids manual rule-based mapping and can adapt to changes in schemas by updating prompt sentences and attribute descriptions, rather than rewriting procedural logic. This reduces maintenance overhead and contributes to improved system adaptability.

The server further uses a geospatial computation sub-module to compute distance information between the user's location and each candidate item returned by the database. The server may use a geospatial library that implements a haversine formula or a spherical law of cosines to compute distances from latitude and longitude pairs. The server represents these distances as numerical values in a distance field. The server stores candidate information, including the computed distance metrics, in an in-memory data structure such as an array of records or a list of structured objects. By computing precise distances at the server and encoding them as part of the data, the system reduces the need for the terminal to perform additional geospatial computations, thus reducing processing load on the terminal and saving battery power.

The server uses the solution presentation module to generate a second prompt sentence that includes the candidate information and the computed geospatial metrics. For example, the server can generate a prompt sentence such as:

“You are a generative AI model that summarizes search results for a user.

The user asked: ‘Please tell me the nearest restaurant.’

The following list shows candidate restaurants with name, distance in meters, and opening hours:
1) Restaurant A, 120 m, 11:00-22:00
2) Restaurant B, 250 m, 10:00-20:00
3) Restaurant C, 500 m, 24 hours

Summarize the best 1-2 options in polite, concise English, and explain why they are suitable based on distance and opening hours.”

The server sends this second prompt sentence to the generative AI model. The generative AI model then uses its attention mechanism to consider both the textual context and the numeric distance data provided in textual form, and generates a ranked explanation and a selected subset of candidate information. The server parses the output and maps the references made by the generative AI model to the underlying records. The server constructs personalized solution information containing both a natural-language explanation and machine-readable identifiers for the selected items.

The terminal receives the personalized solution information and displays it in the communication application. The terminal renders a list of selected items, including names, distances, and operating times, and enables the user to select an item. If the terminal has access to a map application or a navigation application, the terminal can pass the selected location as a parameter to that application, thereby enabling route guidance. In this way, the system is linked to real-world device control and navigation functions, not remaining merely in abstract data processing.

The server achieves a technical improvement in several aspects. First, by using the generative AI model as a generator of search and processing conditions, rather than only as a natural-language answer generator, the server offloads complex logic derivation to a trained model that uses a non-conventional, feature-rich mapping from unstructured text and schema descriptions to structured conditions. This reduces the complexity of rule-based engines and eliminates many branches of conditional logic that are difficult to maintain. As a result, the server can generate more precise queries and reduce the number of redundant or broad searches, leading to reduced database load and faster response times.

Second, by integrating geospatial computation into the server pipeline and feeding computed distances back into the generative AI model via structured prompt sentences, the server enables the generative AI model to perform location-dependent reasoning and ranking based on exact numeric measures rather than approximate textual descriptions. This yields improved accuracy in ranking facilities by proximity and availability and reduces the probability of returning suboptimal recommendations. The technical effect manifests as an improvement in the quality of search results and a reduction of error rates in identifying the nearest or most appropriate facilities.

Third, by storing behavior history information and location information as support information and by dynamically modifying prompt sentences to include such support information, the server can adjust the generative AI model's behavior at runtime without retraining. For instance, if the user repeatedly selects a specific type of facility, the server can include cues in the prompt sentence indicating a preference for that facility type. This allows the generative AI model to bias its condition generation toward preferred categories. Because this behavior is implemented by data-driven prompt construction, the server improves adaptivity while maintaining a fixed model, thus avoiding the computational cost of continuous retraining.

Fourth, the server defines explicit data structures for prompt sentences, filters, sort criteria, candidate information, and structured data representing geospatial computations. The server enforces conversion rules between textual filter expressions and internal query plans. These rules are implemented as parsers and mappers and are distinct from natural human reasoning. Therefore, the processing pipeline is not a mere automation of human mental activities but rather a machine-specific technique that uses non-traditional formats and intermediate representations optimized for computational efficiency.

The user benefits from the system because the terminal can retrieve high-quality, context-aware, and location-dependent answers with reduced latency and without needing to implement complex logic locally. The user's device thus uses network bandwidth and energy more efficiently, as the server performs heavy computation and optimization. The causality between the described processing and the technical effects is as follows: the structured prompt sentence design and the generative AI model's architecture enable the extraction of query conditions from unstructured natural language; these conditions guide targeted database access with geospatial computation; and this targeted access reduces unnecessary data retrieval and computation, thereby improving processing speed and accuracy.

In alternative embodiments, the server can use different types of databases, such as document-oriented databases or search engines with geospatial indexing, provided that the search and computation module maps the derived filters and sort criteria to the corresponding query language. The server can also use a locally deployed generative AI model, such as a transformer-based model running on a graphics processing unit cluster, instead of an external service, as long as the model processes prompt sentences containing schema descriptions and location information to generate search and processing conditions.

The server may also vary the neural network architecture. For example, the generative AI model can incorporate encoder-decoder layers or mixture-of-experts modules to handle both schema reasoning and natural language summarization. The training method can include multi-task learning, where the model learns both to answer questions and to propose database filter expressions, using synthetic training pairs generated by augmenting schema descriptions with random queries. The loss function can include a composite term that penalizes incorrect filter syntax in addition to incorrect token predictions. These architectural and training variations still align with the invention, as they preserve the core concept of using a generative AI model, guided by prompt sentences, to generate machine-executable conditions that drive concrete database and geospatial computations on the server.

In another embodiment, the terminal can incorporate additional sensors, such as accelerometers or proximity sensors, and the server can incorporate these signals into support information. The server can then adjust prompt sentences accordingly, for example by inferring whether the user is moving or stationary and requesting locations suitable for walking or driving distances. These variations further demonstrate that the invention is implemented as a technical system that uses sensor data, server-side computation, and an AI model-driven query synthesis process to improve the functioning of the computer system as a whole.

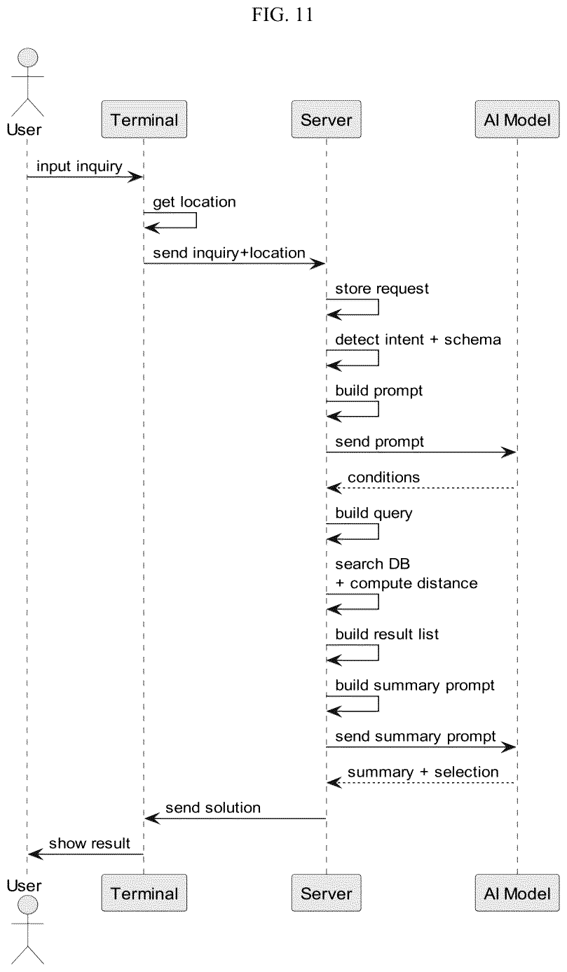

The following describes the processing flow using FIG. 11.

### Step 1

The user operates the terminal to start a communication application and input an inquiry.

The terminal receives, as input, a character string representing the inquiry (for example, “Please tell me the nearest restaurant.”).

The terminal executes a text acquisition process that reads the content of a text input field from the user interface, stores the character string temporarily in working memory, and associates it with a session identifier.

The terminal outputs a structured inquiry object including at least the inquiry text and a session identifier to an internal communication module.

### Step 2

The terminal acquires location information corresponding to the user's current position.

The terminal receives, as input, a request from the communication module to obtain location information for the current session.

The terminal calls an operating-system-level location service, which aggregates signals from a positioning module (such as a GPS receiver, Wi-Fi positioning, or cellular network triangulation), converts raw sensor values into geographic coordinates, and returns latitude and longitude values.

The terminal performs a data integration operation that combines the inquiry object and the latitude/longitude pair into a request payload with fields including inquiry text, coordinates, user identifier, and timestamp.

The terminal outputs the request payload to a network transmission module.

### Step 3

The terminal transmits the request payload to the server via a communication network.

The terminal receives, as input, the structured request payload.

The terminal performs a serialization process that encodes the payload into a message format such as a JSON text and encapsulates the message into a network packet using a transport protocol such as HTTPS.

The terminal sends the packet to a predefined server endpoint and outputs the transmitted packet onto the network interface.

### Step 4

The server receives the request payload from the terminal and stores it.

The server receives, as input, network packets containing the serialized payload.

The server executes a deserialization process that decodes the packets, reconstructs the JSON or equivalent structure, and extracts fields including the inquiry text, the coordinates, the user identifier, and the timestamp.

The server performs a data storage operation that inserts these fields into a persistent data structure, such as a relational database table, and assigns a unique request identifier.

The server outputs an internal request record containing the request identifier and the extracted user information to subsequent processing modules.

### Step 5

The server determines the intention of the inquiry information.

The server receives, as input, the internal request record including the inquiry text and optional behavior history linked to the user identifier.

The server executes an intent classification algorithm, which may include tokenization of the inquiry text, vectorization of tokens into numerical feature vectors, and evaluation of the vectors by a classifier such as a neural-network-based or statistical model stored in memory.

The server computes, from these features, one or more intent labels (for example, “location-based search” and “facility type: restaurant”) and a confidence score for each label.

The server outputs an intent representation that includes the selected intent label, the confidence values, and references to the original user information.

### Step 6

The server retrieves attribute information of information resources of an organization group and prepares schema data.

The server receives, as input, the intent representation indicating the type of information resources to use (for example, facilities database).

The server performs a metadata query on a schema repository or configuration store, retrieving field names, data types, and index information for the relevant information resources (for example, fields such as id, name, category, latitude, longitude, and opening_hours).

The server aggregates the retrieved attributes into a schema description string and optionally normalizes field names to a canonical form to reduce ambiguity.

The server outputs a schema data object that specifies the available attributes and their semantics to a prompt sentence generation module.

### Step 7

The server generates a primary prompt sentence for a generative AI model.

The server receives, as input, the intent representation, the user's location information, the schema data object, and the original inquiry text.

The server executes a template-based text assembly process: it selects a template associated with the detected intent, inserts the actual inquiry text, the numeric coordinates, and a textual description of the schema fields into specific placeholder positions, and applies formatting rules to produce a coherent instruction.

The server thereby performs a transformation from internal structured data (intent, schema, location) into a linear token sequence that is optimized for processing by a transformer-based generative AI model.

The server outputs a prompt sentence such as:

“You are a generative AI model that designs location-based search logic. The user asked: ‘Please tell me the nearest restaurant.’ The user's current location is latitude 35.681236, longitude 139.767125. The organization group provides a database with fields: id, name, category, latitude, longitude, opening_hours. Create conditions and sorting logic to find the nearest restaurant that is currently open. Return your answer as a short explanation followed by filters and sort criteria in plain text.”

### Step 8

The server transmits the primary prompt sentence to the generative AI model and obtains structured conditions.

The server receives, as input, the prompt sentence and model configuration parameters such as maximum token limit and randomness level.

The server performs a request-formation operation that encodes the prompt sentence into a request body accepted by the AI model API, attaches authentication data, and sends it over a secure network channel.

The generative AI model, on a separate computing infrastructure, transforms the prompt sentence into an output token sequence using its trained transformer architecture and learned parameters; the server receives the response text as an output from the API.

The server parses the response text by pattern matching and token splitting to separate an explanation portion and a conditions portion, and further decomposes the conditions portion into explicit filter items (for example, “category =restaurant”, “open_now =true”) and sort criteria (for example, “distance ascending”).

The server outputs a conditions object containing parsed filters, sort keys, and any auxiliary parameters.

### Step 9

The server generates query data for searching information resources of the organization group.

The server receives, as input, the conditions object, the user's location information, and the schema data object.

The server constructs a query plan by mapping each logical filter in the conditions object to an attribute in the schema data object and by mapping the sort criteria to a geospatial sort expression based on the latitude and longitude fields.

The server executes a query synthesis operation that converts the query plan into a machine-executable query string or query structure recognized by a database engine, and binds the user's coordinates as numerical parameters.

The server outputs a database query data structure that is ready to be submitted to an information management apparatus.

### Step 10

The server performs a search on the information resources and obtains candidate information.

The server receives, as input, the database query data structure.

The server sends the query to a database or search engine that stores the information resources of the organization group, where the engine executes filtering on category, evaluation of opening hours against the current timestamp, and preliminary distance computation using a geospatial index.

The database returns a set of records satisfying the conditions; the server deserializes the records into a list of candidate entries, each entry containing at least an identifier, name, coordinates, and opening hours.

The server may additionally compute more precise distances by applying a geospatial function to the coordinates of each candidate and the user's coordinates.

The server outputs a candidate information list including each candidate's attributes and an associated distance value.

### Step 11

The server computes structured geospatial data from the candidate information.

The server receives, as input, the candidate information list and the user's coordinates.

The server executes a distance computation algorithm, such as a haversine formula implementation, for each candidate to transform pairs of latitude and longitude into scalar distance values in meters or kilometers.

The server performs a sorting operation on the candidate list based on the computed distance values, optionally truncating the list to a fixed number of top candidates to reduce subsequent computational load.

The server then constructs structured geospatial data by pairing each candidate identifier with its distance and any additional score, and it outputs a structured data object that encodes candidates, ordered distances, and metadata for later use.

### Step 12

The server generates a secondary prompt sentence for summarizing or ranking candidate information.

The server receives, as input, the structured geospatial data, the candidate information list, and the original inquiry text.

The server performs a formatting process that converts each candidate into a compact textual description including name, distance, and opening hours, and concatenates these descriptions into a list segment embedded in an instruction.

The server inserts this list segment and the user's inquiry text into a template designed to instruct the generative AI model to summarize and rank options.

The server outputs a secondary prompt sentence such as:

“You are a generative AI model that summarizes search results for a user. The user asked: ‘Please tell me the nearest restaurant.’ The following list shows candidate restaurants with name, distance in meters, and opening hours: 1) Restaurant A, 120 m, 11:00-22:00; 2) Restaurant B, 250 m, 10:00-20:00; 3) Restaurant C, 500 m, 24 hours. Summarize the best 1-2 options in polite, concise English and explain why they are suitable based on distance and opening hours.”

### Step 13

The server transmits the secondary prompt sentence to the generative AI model and obtains personalized solution information.

The server receives, as input, the secondary prompt sentence.

The server performs an API call similar to that of the primary prompt, sending the secondary prompt sentence as a request body and receiving a response containing a ranked explanation and references to the candidate items.

The server parses the response text to extract a natural-language explanation and candidate identifiers or ordinal references (for example, “1 and 2” corresponding to the first and second candidates).

The server maps these references back to the candidate information list by index or identifier and constructs personalized solution information that includes the explanation and the corresponding candidate records.

The server outputs a solution package data structure ready for delivery to the terminal.

### Step 14

The server transmits the personalized solution information to the terminal.

The server receives, as input, the solution package data structure and the user's terminal identifier or session identifier.

The server executes a response-formation process that serializes the solution package into a message format such as a JSON object containing fields for explanation text, item names, distances, and opening hours.

The server sends this serialized message over the network to the terminal using a response message of the communication protocol.

The server outputs the transmitted message onto the network interface, completing the server-side processing for the current inquiry.

### Step 15

The terminal receives the personalized solution information and presents it to the user.

The terminal receives, as input, the response message containing the serialized solution package.

The terminal performs a deserialization process to reconstruct the solution package into internal data structures such as arrays of items and a text string for the explanation.

The terminal executes a rendering process in the communication application, in which it populates user interface components (for example, a text view and a list view) with the explanation text and a list of facilities including distances and opening hours.

The terminal outputs the displayed information on the screen, and the user views the personalized solution information and may select an item or issue a further inquiry.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented consultation systems that rely on generative AI models typically forward raw user inquiries directly to a generative AI model and return the generated text to a user terminal without deeply integrating the generated output with structured business data. Such architectures suffer from several technical problems. First, when raw, unstructured inquiries are passed directly to a generative AI model, the model input is often ambiguous and lacks sufficient operational context. This can lead to non-deterministic, verbose, or catalog-incompatible outputs that are difficult for downstream components to process in an automated manner. As a result, additional manual or ad hoc post-processing on the client side is required, which increases processing overhead and latency in the overall computer system.

Second, typical systems do not systematically transform the user inquiry into a structured prompt sentence that encodes both conversational context and machine-readable constraints. Without such structured prompt construction on the server side, the generative AI model output cannot be reliably mapped to product attributes, categories, or other structured fields maintained in enterprise databases. This disconnect degrades the technical efficiency of query generation for backend information repositories and results in redundant database lookups, inefficient attribute matching, and higher resource consumption on processors, memory, and network components.

Third, existing systems generally treat each user inquiry as an isolated request and fail to maintain a robust, machine-processable conversation history at the server. Without conversation-aware prompt generation, the generative AI model cannot leverage prior turns of the interaction to disambiguate references, refine constraints, or maintain user context over multiple exchanges. This leads to repeated transmission of redundant data, repeated inferences on similar content, and inconsistent responses that require additional client-side reconciliation, thereby reducing the throughput and responsiveness of the system.

Fourth, although some systems may consider user history or location at an application level, they typically do not integrate past usage history information, behavior history information, preference information, and location information into the prompt construction logic in a way that directly optimizes the computational behavior of the generative AI model and subsequent database query generation. As a result, backend search operations are often overbroad, leading to unnecessary scanning of large information sets, poor cache locality, and increased load on storage subsystems.

Accordingly, there is a need for a computer-implemented technique that, at the server side, (i) converts user inquiries into structured prompt sentences with explicit context, (ii) drives a generative AI model in a way that yields machine-interpretable solution information, (iii) automatically derives attribute-level search conditions from the generated solution information, and (iv) maintains conversational and user-specific context to personalize and constrain backend queries. Such a technique should improve the technical operation of the server and its cooperation with terminals, generative AI models, and information repositories by reducing unnecessary computation, bandwidth usage, and storage access, while generating consistent and catalog-aligned response data.

The specific processing by the specific processing unit 290 of the data processing device 12 in Application Example 1 is realized by the following means.

The present invention provides a server comprising a processor configured to receive, from a terminal over a network, information including an inquiry from a user; analyze the received inquiry as character information to extract an intention and a related target of the inquiry; generate, on the basis of the extracted intention and the related target, a structured prompt sentence suitable for interactive information generation processing by combining the inquiry with template information and context information; convert the prompt sentence into a sequence of tokens; cause a generative AI model to execute an inference process by using the sequence of tokens as input to generate solution information representing a solution corresponding to the inquiry; extract attribute information and category information from the solution information; generate a search condition for performing a query process on an information set held by a business entity on the basis of the attribute information and the category information; execute a search process on the information set on the basis of the search condition to acquire related information; integrate the solution information and the related information to generate response information having a structure presentable to the user; transmit the response information to the terminal via a user interface for display; and, in a case of multiple interactions with the user, store past inquiries and past solution information as a conversation history and generate the prompt sentence including the conversation history so as to cause generation of solution information consistent with multi-turn dialogue, and further configured, in certain embodiments, to acquire past use history information, behavior history information, preference information, and location information associated with the user and incorporate at least part of such information into the template information and the context information used for constructing the prompt sentence so that the generative AI model generates personalized solution information and the search condition is constrained to a relevant subset of the information set. This enables the server to technically improve the end-to-end consultation process by transforming unstructured user inquiries into context-rich prompt sentences that drive the generative AI model to produce catalog-compatible, machine-interpretable solution information, by automatically deriving efficient and targeted search conditions for backend information sets, by reducing redundant computation and storage access through conversation-aware and user-aware context management, and by delivering consistent, personalized, and rapidly generated response information to the terminal with improved utilization of processing, memory, and network resources in the overall computer system.

The term “system” refers to a combination of one or more computing devices, communication networks, storage components, and software modules that cooperate to execute the processes described herein.

The term “processor” refers to one or more hardware processing units, such as a central processing unit or a graphics processing unit, that execute instructions to perform data processing operations.

The term “terminal” refers to an information processing device operated by a user, such as a portable device, a stationary device, or any other computing device capable of network communication and user interaction.

The term “network” refers to a communication infrastructure, including wired or wireless links and associated protocols, that enables data transmission between the server, the terminal, and other components.

The term “user” refers to an individual or an organization that issues inquiries and receives response information through the system.

The term “inquiry” refers to information indicating a question, request, or problem description provided by a user for which a solution or recommendation is to be generated.

The term “character information” refers to data representing textual content encoded in a character set, such as a sequence of symbols or codes corresponding to letters, digits, or other textual elements.

The term “intention” refers to a meaning, goal, or purpose inferred from the inquiry, indicating what the user seeks to achieve or obtain.

The term “related target” refers to an object, item, category, service, or concept identified as being the subject of the user's inquiry.

The term “prompt sentence” refers to a text sequence constructed for input to a generative AI model, the text sequence including at least part of the inquiry and additional context so as to guide generation of solution information.

The term “template information” refers to predefined text patterns, structural formats, or rule sets that are combined with inquiry content to generate a prompt sentence in a consistent and machine-processable form.

The term “context information” refers to supplementary data, including at least one of conversation history, user characteristics, environmental conditions, or system state, that is combined with the inquiry to generate a prompt sentence.

The term “sequence of tokens” refers to an ordered series of discrete units derived from a prompt sentence by a tokenization process, each unit representing a word, subword, character, or other text segment.

The term “generative AI model” refers to a machine learning model configured to produce output data, such as natural language text, in response to input data, the machine learning model being trained on example data and executed by the processor.

The term “inference process” refers to a computation process in which a trained generative AI model receives input data and calculates output data without modifying model parameters.

The term “solution information” refers to data generated by the generative AI model that represents a proposed answer, recommendation, or procedure for addressing the user's inquiry.

The term “attribute information” refers to data elements representing properties or characteristics of an item or service, such as type, color, category, or other feature, which are extracted from solution information.

The term “category information” refers to data indicating a classification or grouping of items or services, which is derived from the solution information and used for search and retrieval.

The term “search condition” refers to a set of constraints, parameters, or criteria generated by the processor and applied to an information set to retrieve related information.

The term “information set” refers to a logically organized collection of data records, such as a database or data store, maintained by a business entity and accessible by the server.

The term “business entity” refers to an organization, institution, or enterprise that provides products, services, or information and maintains at least part of the information set.

The term “search process” refers to a series of operations that apply a search condition to an information set to identify and retrieve related information.

The term “related information” refers to data obtained from the information set that satisfies the search condition and is relevant to the solution information and the user's inquiry.

The term “response information” refers to data generated by the processor that combines at least the solution information and the related information into a structure suitable for presentation to the user.

The term “user interface” refers to a software-based or hardware-based interface that enables presentation of information to the user and reception of inputs from the user.

The term “conversation history” refers to stored data representing at least past inquiries and past solution information associated with a user, maintained over multiple interactions.

The term “multi-turn dialogue” refers to a sequence of two or more related exchanges between a user and the system, where later exchanges are influenced by earlier exchanges.

The term “past use history information” refers to data indicating previous interactions of the user with an information acquisition device or service, including records of inquiries, selections, or operations.

The term “behavior history information” refers to data describing actions or patterns of actions of the user over time, including at least one of browsing behavior, purchase behavior, or selection history.

The term “preference information” refers to data indicating user likes, dislikes, priorities, or tendencies, inferred or explicitly provided, that may affect generation of solution information.

The term “location information” refers to data indicating a geographical position, region, or place associated with the user or the terminal, obtained through sensors, network information, or other means.

The term “information acquisition device” refers to any device or subsystem used by the user to obtain information from the system, including but not limited to the terminal.

The term “personalized solution information” refers to solution information generated by the system that is adapted to a particular user based on at least one of behavior history information, preference information, or location information.

In one embodiment, a server cooperates with a terminal and a user to implement a consultation system that generates solution information by using a generative AI model and structured prompt sentences, and that integrates the generated solution information with an information set held by a business entity.

The server includes at least one processor, a memory, a network interface, and a non-transitory storage medium storing instructions. The processor executes the instructions to perform the functions described in the claims. The server uses general-purpose hardware such as a multicore central processing unit and, in some embodiments, an accelerator such as a graphics processing unit. The server executes software including an operating system, an application server framework, a network communication stack, a database driver, and a machine learning runtime. For example, the server executes a machine learning framework such as a tensor-based computation library implementing automatic differentiation, and executes an application framework such as a web application framework to handle requests from the terminal.

The terminal includes at least a processor, a memory, a display, an input interface, and a network interface. The terminal executes an operating system and an application or browser that presents a user interface. The terminal displays an input field, buttons, and recommendation results and transmits user inquiries and receives response information through the network interface by using a communication protocol such as HTTPS.

The user operates the terminal to input an inquiry. The user observes a user interface displayed on the terminal and enters textual content as an inquiry. For example, the user may input the following text:

“I am looking for a tie that matches this shirt. What do you recommend?”

The terminal converts user keystrokes or touch input into character codes and stores the inquiry as a character string in memory. The terminal then transmits the character string to the server as part of a request message via the network interface.

The server receives the inquiry and stores the corresponding request data in memory. The server analyzes the inquiry as character information by executing text-processing instructions. The server executes normalization operations such as character encoding unification, removal of redundant whitespace, and conversion of script variants. The server then executes lexical analysis to divide the inquiry into tokens at the application level, independent of the tokens used by the generative AI model. The server identifies parts of speech and recognizes key terms such as product types and descriptive attributes by using pattern-matching rules and lookup tables stored in the memory.

The server extracts an intention and a related target from the inquiry by using rule-based logic and, in some embodiments, a light-weight classifier distinct from the generative AI model used for solution generation. For example, when the inquiry is “I am looking for a tie that matches this shirt. What do you recommend?”, the server identifies an intention corresponding to “request for recommendation” and a related target corresponding to a “neckwear item” associated with a previously specified “shirt” item.

The server constructs a prompt sentence by combining the normalized inquiry with template information and context information. The template information is stored in the storage medium as one or more text strings including placeholders. The context information may include store type, product domain, conversation history, user preference information, and user location information. The server selects one template based on the extracted intention and related target and performs variable substitution to insert the normalized inquiry and the context information into the template.

For example, the server may generate a prompt sentence as follows:

“Context: You are an in-store stylist system. User question: I am looking for a tie that matches this shirt. What do you recommend? Respond with the recommended color and pattern of the tie in one concise sentence, so that the answer can be mapped to catalog attributes.”

In another embodiment, when the user has issued multiple inquiries, the server incorporates conversation history into the prompt sentence. For example, the server may generate a prompt sentence as follows:

“Context: You are an in-store stylist system.

Previous question: I am looking for a tie that matches this shirt. What do you recommend?

Your previous answer: A blue striped tie will match this shirt well.

New question: Show me a cheaper option.

Respond with the recommended color, pattern, and price range of the tie in one concise sentence, so that the answer can be mapped to catalog attributes.”

The server stores conversation history in a data structure in the memory. The data structure is, for example, a list or sequence of pairs of inquiry text and solution information text, optionally with timestamps and identifiers. By organizing conversation history in this structured form, the server can efficiently retrieve relevant past turns and incorporate them into the prompt sentence in a controlled manner, rather than simply concatenating all previous content.

The server converts the prompt sentence into a sequence of tokens by using a tokenizer corresponding to the generative AI model. The tokenizer implements a predetermined subword segmentation algorithm, such as byte-pair encoding or a unigram language model, and maps each segment to an integer identifier. The server executes the tokenizer on the prompt sentence to produce an ordered array of integers representing the sequence of tokens.

The server applies the sequence of tokens as input to the generative AI model. In one embodiment, the generative AI model is a transformer-based neural network including an embedding layer, a plurality of attention blocks, and an output projection layer. The embedding layer converts each token identifier into a continuous vector representation. The attention blocks apply self-attention and feed-forward transformations to the embedded sequence. Each attention block computes attention weights by performing matrix multiplications between query, key, and value representations, applies softmax normalization, and aggregates weighted values. The output projection layer maps the final hidden representations to a probability distribution over token identifiers by applying a linear transformation and a softmax function.

The server executes the generative AI model in an inference mode. The server supplies the token sequence to the embedding layer, stores the resulting vectors in memory, and iteratively applies the attention blocks to compute subsequent hidden states. The server generates output tokens by using a decoding strategy such as greedy search or beam search. During this process, the server repeatedly selects the next token with the highest probability or a constrained set of tokens fulfilling predetermined criteria. The server terminates decoding when the sequence reaches a predefined maximum length or an end-of-sequence token.

The server decodes the generated sequence of tokens to produce solution information in the form of a text string. For example, the server may obtain:

“A blue striped tie will match this shirt well.”

The server then executes a post-processing module that removes unnecessary preambles and enforces a structural constraint. The post-processing module uses pattern matching to identify a color phrase and a pattern phrase. For example, the server extracts “blue” as color attribute information and “striped” as pattern attribute information, and identifies “tie” as category information. The server maps these textual attributes to internal codes by using a mapping table stored in the storage medium. For instance, the server converts “blue” to a color code and “striped” to a pattern code and converts “tie” to a category code.

The server generates a search condition for an information set held by a business entity. The information set is implemented as a relational database or a key-value store. The server represents the search condition as a structured query object including at least the category code, the color code, the pattern code, and, optionally, location information corresponding to a physical store. The server uses a database driver to transform the query object into a database query expression and transmits the query expression to a database engine. The database engine executes index lookups and range scans on storage devices such as solid-state drives to retrieve records matching the search condition.

The server receives related information from the database engine, such as product identifiers, descriptions, prices, and stock quantities. The server integrates the solution information and the related information into response information conforming to a predetermined schema. The response information contains a field for the solution information and one or more fields for elements such as product attributes and availability. The server serializes the response information into a representation such as a text-encoded structure and transmits the response information to the terminal by using the network interface.

The terminal receives the response information and decodes it. The terminal updates the user interface by displaying the solution information and the related information. For example, the terminal may display “A blue striped tie will match this shirt well.” as a recommendation sentence at the top of the screen and display a list of specific items below. The user then views the display, selects an item, or inputs a follow-up inquiry.

The server can incorporate user-specific information into the prompt sentence to achieve personalization and improve computational efficiency. The server acquires past use history information, behavior history information, preference information, and location information from storage. The server encodes such information as concise textual descriptors or structured tags that are appended to the prompt sentence. For instance, the server may generate a prompt sentence including the phrase “User prefers simple designs and mid-range prices, and is currently in store A.” in order to bias the generative AI model toward solutions consistent with the user's historical behavior and the inventory of the current store.

By explicitly encoding such information into the prompt sentence, the server constrains the generative AI model's output space and reduces the number of unnecessary tokens generated. As a result, the length of the solution information is reduced, and the number of database searches on irrelevant categories or attributes is decreased. This leads to reduced processor cycles, lower memory access, and improved cache performance during both inference and database querying, thereby improving the technical functioning of the server.

The server also implements specific training procedures for the generative AI model to optimize its behavior for this architecture. In one embodiment, the server or an associated training system trains the generative AI model on pairs of prompt sentences and target solution sentences that explicitly encode catalog-aligned attributes. The server defines a loss function that penalizes divergence from catalog attributes and from a constrained output format. The loss function is, for example, a cross-entropy function normalized by a mask that selects only attribute-relevant tokens. The server updates model parameters by using gradient-based optimization such as stochastic gradient descent with adaptive learning rates. The server may employ data augmentation by synthetically generating paraphrased prompt sentences and corresponding attribute-consistent solution sentences to increase robustness to inquiry variations.

By shaping the generative AI model in this way, the server induces an internal representation in which attribute-level information is strongly aligned with specific token patterns. Consequently, the subsequent extraction of attribute information and category information from solution information requires fewer computational resources and yields lower error rates compared to a model trained without such constraints. This alignment reduces the need for complex downstream natural language understanding modules and thus shortens the end-to-end processing pipeline.

The server uses non-conventional rules for constructing prompt sentences and mapping solutions to database queries. In contrast to a simple echo of the user inquiry, the server enforces a rule that every prompt sentence explicitly contains (i) a role specification for the generative AI model, (ii) a machine-readable instruction to output attributes in a constrained form, and (iii) a context block with conversation history and user factors encoded in a normalized pattern. This rule causes the generative AI model to output solution information that is both intelligible to the user and consistently parsable by the server, thereby improving the technical predictability and reproducibility of the processing.

The server further divides functional modules into separate components: a prompt construction module, a generative inference module, an attribute extraction module, a query generation module, and a response assembly module. Each module uses specific data structures and interfaces. For example, the prompt construction module outputs prompt sentences and metadata encapsulated in a record with fixed fields. The attribute extraction module consumes solution information and outputs attribute codes as an array of identifiers. By defining these clear interfaces, the server enables independent optimization of modules and facilitates pipelining and parallelization on multicore processors. This modular design improves throughput and reduces processing latency compared with monolithic implementations.

The terminal can be deployed in a physical retail environment or other real-world settings where real-time recommendations are needed. In such settings, the server's ability to incorporate location information and inventory constraints into prompt sentences and search conditions directly affects physical resource utilization. For example, by restricting search conditions to inventory available at a specific store, the server reduces network traffic between data centers and satellite systems and minimizes transmission of irrelevant items that cannot be physically provided. This coupling between digital processing and physical inventory control demonstrates that the invention goes beyond abstract data manipulation and enhances the operation of computer networks and storage systems in connection with real-world resources.

In an alternative embodiment, the server executes the generative AI model on specialized hardware such as a neural processing unit. The server schedules inference tasks in a way that groups prompt sentences by domain or attribute type to maximize reuse of cached parameter values. For instance, when multiple terminals in the same store submit inquiries related to similar product categories, the server batches the corresponding prompt sentences and executes a single batched inference call. This reduces overhead in the neural network runtime, improves utilization of vectorized instructions, and lowers energy consumption. Such scheduling constitutes a technical optimization of the underlying computing platform independent of the business logic.

In another embodiment, the server maintains multiple generative AI models with different sizes and capabilities. The server selects a model based on complexity of the inquiry and latency requirements. For simple inquiries that map directly to a small number of attributes, the server uses a smaller model to reduce inference time and resource usage. For complex, multi-constraint inquiries, the server uses a larger model. The selection logic is based on features extracted from the inquiry, such as length, domain keywords, and presence of sentiment or multi-clause structures. This adaptive model selection further improves computational efficiency and demonstrates a concrete improvement in computer operation.

By implementing these embodiments, the server, the terminal, and the generative AI model cooperate to realize a consultation system that is not merely an automation of human reasoning but an improvement to computer technology itself. The system improves processing speed by reducing unnecessary token generation and database access; improves accuracy by aligning model outputs with structured attributes through specialized training and constrained prompts; improves data management by using structured conversation histories and attribute codes; and reduces communication load by limiting search conditions to relevant subsets of the information set and batching inference operations. The described configurations, data structures, and non-conventional processing rules provide concrete, technical solutions that enable a person skilled in the art to implement the claimed invention on standard computing hardware.

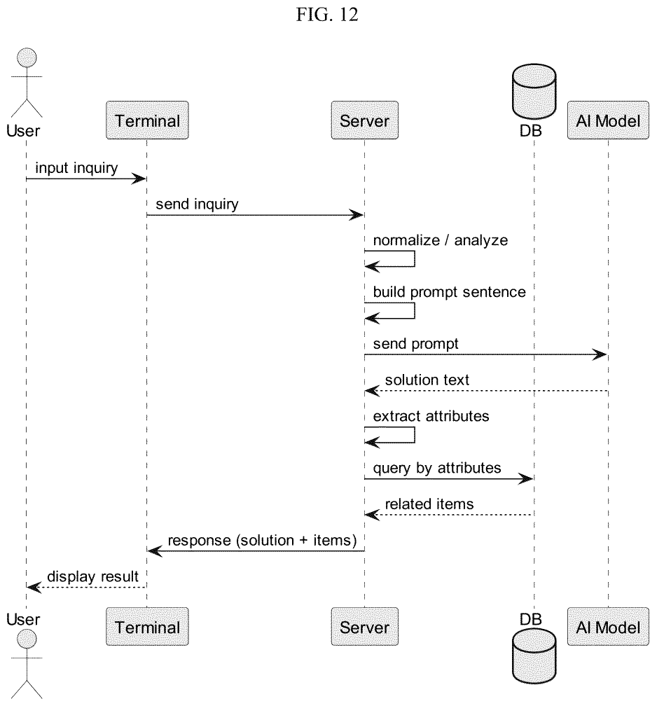

The following describes the processing flow using FIG. 12.

### Step 1

User operates the terminal to input an inquiry.

User views an input screen on the terminal and types a text inquiry, for example, “I am looking for a tie that matches this shirt. What do you recommend?”.

User presses a send button to submit the inquiry.

Input: raw user keystrokes or touch events.

Output: a character string stored in the terminal's memory representing the inquiry text.

### Step 2

Terminal converts the user input into a request and transmits it to the server.

Terminal encodes the inquiry text in a standard character encoding, attaches metadata such as a user identifier and a session identifier, and constructs a request message.

Terminal uses a network protocol stack to establish a secure connection and sends the request message to the server.

Input: inquiry character string and local metadata (user ID, session ID, timestamp).

Output: a structured network request containing the inquiry text and metadata, transmitted to the server.

### Step 3

Server receives the request and normalizes the inquiry text.

Server accepts the network connection, parses the request format, and extracts the inquiry text and metadata.

Server performs text normalization, including conversion to a uniform encoding, removal of redundant whitespace, and normalization of punctuation and letter case.

Input: structured network request with raw inquiry text.

Output: a normalized inquiry string and associated metadata stored in server memory.

### Step 4

Server analyzes the normalized inquiry to extract intention and related target.

Server applies lexical analysis and pattern-matching rules to segment the inquiry into tokens, identify key terms, and determine a request type such as “recommendation request”.

Server uses a rule set or classifier to map key terms (for example, “tie”, “shirt”, “matches”) to internal category indicators and target objects.

Input: normalized inquiry string.

Output: intention data (for example, “request recommendation”) and related target data (for example, category: “neckwear”, reference item: “shirt”), represented as structured fields.

### Step 5

Server constructs a prompt sentence by combining the inquiry with template information and context information.

Server selects a template string based on the intention and target, retrieves conversation history and user-specific context (such as preferences or location), and inserts the normalized inquiry and context elements into placeholders of the template.

Server generates a prompt sentence such as: “Context: You are an in-store stylist system. User question: I am looking for a tie that matches this shirt. What do you recommend? Respond with the recommended color and pattern of the tie in one concise sentence, so that the answer can be mapped to catalog attributes.”

Input: normalized inquiry string, intention data, target data, template information, and context information.

Output: a constructed prompt sentence stored as a character string.

### Step 6

Server converts the prompt sentence into a sequence of tokens for the generative AI model.

Server invokes a tokenizer associated with the generative AI model to segment the prompt sentence into subwords or symbols and map each segment to an integer identifier.

Server arranges the identifiers in order to form an array representing the token sequence.

Input: prompt sentence string.

Output: an ordered sequence of token identifiers suitable for neural network input.

### Step 7

Server performs inference with the generative AI model using the token sequence.

Server loads parameters of a trained neural network model, applies an embedding layer to convert token identifiers into vectors, and processes the vectors through multiple attention blocks and feed-forward layers.

Server executes a decoding algorithm such as greedy decoding or beam search to iteratively select output tokens with the highest probability under model predictions.

Input: sequence of input token identifiers.

Output: sequence of output token identifiers representing generated text.

### Step 8

Server decodes the output token sequence into solution information.

Server applies the tokenizer's decode function to map the output token identifiers back to text units and concatenates them into a coherent sentence.

Server removes unnecessary phrases according to predefined rules to ensure that the text conforms to an attribute-oriented format.

Input: sequence of output token identifiers.

Output: solution text string, for example, “A blue striped tie will match this shirt well.”.

### Step 9

Server extracts attribute information and category information from the solution text.

Server scans the solution text with pattern-matching logic and dictionary lookups to detect color words, pattern words, item types, and other attribute phrases.

Server maps detected phrases to internal attribute codes (such as color codes and pattern codes) and category codes stored in lookup tables.

Input: solution text string.

Output: structured attribute data (for example, color: “blue”, pattern: “striped”) and category data (for example, “tie”) represented as codes.

### Step 10

Server generates a search condition for an information set held by a business entity.

Server combines the attribute codes, category codes, and optional constraints such as store identifier or price range into a query object.

Server converts the query object into a database query expression that specifies conditions on fields such as category, color, pattern, and stock status.

Input: structured attribute data and category data, plus optional context data (store ID, price constraints).

Output: a structured search condition or database query expression.

### Step 11

Server executes a search process on the information set using the search condition.

Server sends the query expression to a database engine, which accesses storage devices, uses indexes, and retrieves records that satisfy the specified conditions.

Server receives matching record sets and converts them into internal data structures representing related information such as product identifiers, descriptions, prices, and availability.

Input: search condition or query expression.

Output: related information records corresponding to items matching the solution attributes.

### Step 12

Server integrates the solution information and the related information into response information.

Server constructs a response object that includes the solution text and a list or set of related items, organizing fields into a predetermined schema.

Server may sort or filter the related items based on additional criteria and attach metadata such as timestamps or confidence indicators.

Input: solution text string and related information records.

Output: structured response information ready for transmission to the terminal.

### Step 13

Server transmits the response information to the terminal.

Server serializes the response information into a transferable format, attaches response headers, and sends the data through the network interface back to the terminal over a secure connection.

Server manages connection state and logs the transaction for later analysis or debugging.

Input: structured response information.

Output: network response message containing the response information delivered to the terminal.

### Step 14

Terminal receives the response information and updates the user interface.

Terminal parses the received data, extracts the solution text and the list of related items, and renders them as visual elements on the display.

Terminal displays the recommendation sentence prominently and arranges related items with details such as name, price, and stock indicator, enabling user interaction through touch or pointer input.

Input: network response message containing response information.

Output: updated screen content showing solution information and related information to the user.

### Step 15

User reviews the displayed information and optionally issues a new inquiry.

User reads the recommendation and inspects the listed items, possibly scrolling, selecting an item, or closing the display.

User may input a follow-up inquiry such as “Show me a cheaper option” in the same interface, which the terminal again converts into a character string and transmits to the server.

Input: displayed solution and related information.

Output: new inquiry text that can initiate a subsequent processing cycle.

### Step 16

Server maintains and updates conversation history to support multi-turn dialogue.

Server stores each inquiry and corresponding solution information as a pair in a conversation history data structure associated with the user or session.

Server, when generating a new prompt sentence for a follow-up inquiry, retrieves relevant entries from the conversation history and embeds them in a context section of the prompt sentence, thereby providing the generative AI model with prior turns for disambiguation and refinement.

Input: current inquiry, current solution information, and previously stored conversation history.

Output: updated conversation history and a context-enhanced prompt sentence for the next inference cycle.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented question-answer systems that utilize machine learning models often treat user inquiries as unstructured text and perform ad hoc processing at the application level. In many cases, the transformation from user input to model input, and from model output back to user-facing responses, is implemented in a scattered and non-standard manner across client and server components. As a result, such systems suffer from several technical problems in terms of computer technology itself.

First, existing systems frequently lack a unified and explicit mechanism in the server for converting natural-language inquiries into structured prompt sentences and further into token sequences suitable for a generative AI model. This causes redundant parsing and formatting logic, inefficient use of processing resources, and difficulty in optimizing the data path between the communication interface, the processor, and the model-execution hardware. The absence of a clearly defined, processor-level prompt-generation pipeline leads to increased latency and inconsistent behavior when handling high volumes of user requests.

Second, many systems are not designed to tightly couple prompt construction with the internal representation and execution characteristics of the generative AI model running on specialized parallel computation hardware. In particular, prior systems do not sufficiently leverage the processor's ability to centrally manage tokenization, numerical computation invocation, and decoding in a manner that is optimized for parallel arithmetic devices and machine-learning software platforms. This often results in suboptimal GPU utilization, unnecessary data transfers, and increased end-to-end response time, thereby degrading the overall throughput and scalability of the system.

Third, existing solutions often manage user interaction history and personalization logic at the application front-end or in loosely integrated services. This separation makes it difficult for the central processor to systematically generate prompt sentences that incorporate user attribute information, usage history information, and inquiry-type information. Consequently, the generative AI model is not consistently provided with context that is formatted and aligned with the model's input representation, which limits the degree to which the model output can be tailored in a computationally efficient and predictable way to individual user situations.

Fourth, the presentation of generated solution information on user terminals, such as conversational views, is frequently handled without a coordinated scheme between the user interface and the server-side processing pipeline. The lack of an integrated architecture for capturing, storing, and transmitting history information from the user terminal back to the processor inhibits systematic reuse of interaction context in subsequent prompt sentences and complicates the maintenance of session continuity at scale.

Accordingly, there is a need for a computer-implemented technique that improves the internal data processing flow of a server-centric system, by (i) standardizing how natural-language inquiries are acquired and transformed into prompt sentences and token sequences, (ii) optimizing the interface between the processor and the generative AI model executing on parallel computation hardware, (iii) enabling the processor to construct context-rich prompt sentences using structured additional information about users and their past interactions, and (iv) coordinating with user terminals that maintain and provide interaction history in a conversational format. By solving these technical problems, the system can achieve reduced processing latency, improved resource utilization, and more reliable, individually adapted generation of solution information through a generative AI model.

The specific processing by the specific processing unit 290 of the data processing device 12 in Example 2 is realized by the following means.

The present invention provides a server comprising a processor and a communication interface, the processor being configured to receive, via the communication interface and over a communication network, inquiry information that has been input in natural language from a user terminal, convert the received inquiry information into structured character-string information as a prompt sentence, convert the prompt sentence into a token sequence conforming to an input format of a generative AI model, input the token sequence into the generative AI model that is implemented by using a parallel arithmetic device and a machine-learning software platform, cause the generative AI model to generate solution information corresponding to the inquiry information by performing numerical computation processing, convert a token sequence output from the generative AI model into character-string information and format the character-string information as the solution information, and transmit the formatted solution information as response data to the user terminal so that the solution information is displayed on a user interface of the user terminal. This enables a technically unified, server-centric processing pipeline that efficiently transforms natural-language inquiries into model-ready prompt sentences and token sequences, executes the generative AI model on specialized parallel hardware with reduced overhead, and returns formatted solution information to conversational user interfaces, thereby improving computational efficiency, throughput, and responsiveness of the overall computer system while supporting individualized generation of solutions.

The term “processor” refers to a hardware processing unit, or a combination of hardware processing units, including at least one central processing unit or equivalent arithmetic logic circuitry, that executes machine-readable instructions to perform data processing operations described in the present specification.

The term “communication interface” refers to a hardware and/or software interface that enables data exchange between the server and external devices over a communication network, and includes at least one network adaptor, network controller, or communication port together with corresponding communication protocol stacks.

The term “communication network” refers to a wired or wireless data transmission infrastructure that interconnects the server and one or more user terminals, and may include public networks, private networks, or combinations thereof.

The term “user terminal” refers to an information processing device operated by a user, the device including at least one input unit, output unit, memory, and communication function, and being capable of sending inquiry information to the server and receiving solution information from the server.

The term “inquiry information” refers to data representing a question, request, or problem description that is input by a user in a natural-language form and transmitted from the user terminal to the server.

The term “natural language” refers to a human language, such as a spoken or written language used for everyday communication, whose sentences are composed of words, phrases, and grammar understandable by human beings rather than by formal programming or markup languages.

The term “structured character-string information” refers to text data that is arranged according to a predetermined format, template, or schema so that its components can be programmatically interpreted, parsed, or processed in a consistent manner.

The term “prompt sentence” refers to structured character-string information generated from inquiry information and optional additional information, the prompt sentence being formatted to serve as an input to a generative AI model for the purpose of causing the model to generate solution information.

The term “token sequence” refers to an ordered set of elements obtained by segmenting a prompt sentence or other character-string information into units, such as words, subwords, or symbols, each unit being represented as an identifier suitable for input to or output from a generative AI model.

The term “generative AI model” refers to a machine-learning model that, in response to input data such as a prompt sentence, generates new data such as text representing solution information, using statistical or learned internal parameters.

The term “parallel arithmetic device” refers to a hardware computation component, including at least one device capable of executing a large number of arithmetic operations in parallel, such as a general-purpose accelerator or dedicated vector processor, used to accelerate execution of the generative AI model.

The term “machine-learning software platform” refers to a software framework, library, or runtime environment that manages model parameters, defines computation graphs or equivalent structures, schedules tensor operations, and interfaces with parallel arithmetic devices to execute machine-learning models.

The term “numerical computation processing” refers to a series of arithmetic operations performed on numerical data, including operations on vectors, matrices, or tensors, for the purpose of applying the generative AI model to input data and obtaining model output.

The term “solution information” refers to data representing an answer, advice, recommendation, or other response content that is generated by the generative AI model based on inquiry information and that is intended to assist the user in addressing the user's problem or request.

The term “response data” refers to data generated at the server side, including at least the solution information and optional metadata, and transmitted to the user terminal for presentation to the user.

The term “user interface” refers to a collection of visual, auditory, or interactive elements presented on the user terminal for enabling the user to input inquiry information and to view solution information.

The term “conversational screen” refers to a user-interface presentation mode in which inquiry information and solution information are displayed in a time-ordered or dialogue-like format, such as alternating messages or segments resembling a conversation.

The term “history information” refers to stored data that records past interactions between the user and the system, including at least prior inquiry information and corresponding solution information, optionally with associated timestamps or identifiers.

The term “storage device” refers to a hardware memory component, such as non-volatile memory or volatile memory, provided in the user terminal or the server, used for storing history information, intermediate data, or control information.

The term “user attribute information” refers to data that characterizes a user, such as user profile data, demographic data, or role data, which can be used to adjust or customize generation of solution information.

The term “usage-history information” refers to data representing prior operations or interactions performed by the user in relation to the system, including past inquiries, accessed contents, or prior solution information, stored for potential reuse in subsequent processing.

The term “inquiry-type information” refers to classification data indicating a category, domain, or type of an inquiry, such as a problem field, topic, or use case, and is used to control or adjust prompt construction and solution generation.

The term “additional information” refers to information other than the immediate inquiry information, including at least one of user attribute information, usage-history information, and inquiry-type information, that is combined with the inquiry information when generating a prompt sentence.

In one embodiment, a server cooperates with one or more terminals operated by users to implement a system for generating solution information by using a generative AI model. The server includes at least one processor, a main memory, a non-volatile storage device, and a communication interface coupled via a bus. The server additionally includes at least one parallel arithmetic device, such as a general-purpose accelerator, connected through a high-bandwidth interconnect. The terminal includes at least one processor, a memory, a display, an input unit such as a touchscreen or keyboard, and a communication module.

The server executes an operating system and an application program configured to perform natural-language processing, prompt-sentence generation, tokenization, execution of the generative AI model, and decoding of model outputs. The server uses a machine-learning software platform, such as a tensor-computation framework, that provides tensor operations, automatic differentiation, and model execution on the parallel arithmetic device. The server uses a tokenizer library that maps sequences of characters to sequences of discrete token identifiers and vice versa.

The server deploys a generative AI model implemented as a multi-layer neural network having a transformer architecture. The server represents the model as a sequence of layers including an input embedding layer, multiple attention blocks, and an output projection layer. Each attention block includes multi-head self-attention sublayers and position-wise feed-forward sublayers, together with normalization sublayers and residual connections. The server stores model parameters (including weight matrices and bias vectors) in the main memory and loads them into the memory space of the parallel arithmetic device when executing the model. The server trains the generative AI model in advance by using a large corpus of text data. The server supplies batched sequences of token identifiers as training inputs and uses a next-token prediction objective as a loss function. The server computes the loss by applying a cross-entropy error function between predicted token distributions and ground-truth next tokens. The server updates the parameters of the model by performing gradient-based optimization, for example using a stochastic gradient descent method or an adaptive variant. The server improves generalization and robustness by employing data augmentation techniques at the text level, such as synonym replacement or sentence reordering where appropriate, and by controlling regularization parameters. After training, the server stores the learned parameters on the storage device and deploys the trained model for inference.

The server uses the communication interface to receive natural-language inquiry information from the terminal. The server interprets the received data as text encoded in a character encoding such as UTF-8. The server stores the text data in memory as a sequence of characters and associates it with a session identifier and optional user identifier. The server then constructs structured character-string information from the inquiry information. The server selects a template for a prompt sentence and inserts the inquiry information into the template or uses the inquiry information as the main body of the prompt sentence.

For example, the server may generate a prompt sentence such as:

“My shoulders are very stiff. What can I do to relieve the stiffness?”

or:

“I have a headache. Is there anything simple I can do at home to feel better?”

or:

“I feel exhausted from work every day. How can I manage stress better?”

In another example, the server may prepend guiding text to the inquiry, such as: “You are a helpful assistant. A user says: ‘My shoulders are very stiff. What can I do to relieve the stiffness?’Please provide practical and general advice.”

The server generates the prompt sentence as a single character string that includes delimiters, control phrases, or role indicators as needed, while maintaining a format compatible with the tokenizer. The server then applies the tokenizer to the prompt sentence. The server maps each substring (for example, a word or a subword unit) to a token identifier according to a predefined vocabulary. The server stores the resulting sequence of token identifiers as an array or tensor in memory.

The server transfers the token sequence from the main memory to the memory of the parallel arithmetic device. The server arranges the tokens into a data structure that the tensor-computation framework can process, such as an integer tensor of shape [batch_size, sequence_length]. The server configures generation parameters, such as maximum output length, temperature for sampling, top-k cutoff, and top-p cumulative probability threshold. The server then invokes a generation routine that performs successive forward passes through the transformer network.

The server causes the generative AI model to compute, for each position in the output sequence, probability distributions over the vocabulary. The server executes attention operations by computing scaled dot products between query and key vectors, applying normalization and softmax functions, and multiplying by value vectors. The server executes feed-forward operations by computing linear transformations and non-linear activations on hidden-state vectors. The server iterates these operations layer by layer. The parallel arithmetic device performs the underlying matrix multiplications and vector operations in parallel across multiple processing units, thereby exploiting the structure of the transformer architecture.

The server performs token sampling or selection according to the configured generation parameters. The server may, for example, select tokens by probability sampling under a temperature-scaled softmax distribution and then apply a top-k or top-p filter to reduce unlikely tokens. The server appends each selected token to the output sequence and re-feeds the updated sequence to the model to compute the next probability distribution until the server reaches an end-of-sequence indicator or a maximum length. The server then obtains a generated token sequence representing solution information.

The server converts the generated token sequence back to a character string by using the tokenizer's decoding function. The server concatenates the character segments corresponding to each token identifier, performs normalization of spacing and punctuation, and removes any control tokens or special markers. The server optionally applies rule-based post-processing, such as deleting repeated sentences, adding line breaks between distinct recommendations, or inserting a standardized cautionary statement. The server treats the resulting text as the solution information to be provided to the user.

The terminal provides a conversational user interface for the user. The terminal displays a chat-like screen where the user can input text and view solution information. The terminal stores inquiry information and corresponding solution information in a storage area as history information. The terminal associates time stamps, message identifiers, and session identifiers with the stored entries. The terminal transmits part or all of the history information to the server as additional context when necessary.

The server processes the history information and user attribute information as additional information for prompt construction. The server aggregates usage-history information, including prior inquiries and solutions, and identifies inquiry-type information, such as categories of health consultation, work stress, or daily life questions. The server generates a context section as part of the prompt sentence, in which the server summarizes past interactions or selects representative entries. The server inserts this context into the prompt sentence in a defined segment, for example before the current inquiry.

The server thereby generates a prompt sentence that may, for instance, include text such as:

“Previous interaction: You said that you often have stiff shoulders, and previous suggestions included stretching and using warm towels. Current question: I feel exhausted from work every day. How can I manage stress better?”

By combining such additional information with the inquiry information, the server conditions the generative AI model on a richer context that is systematically structured.

The server uses deterministic rules and data structures to decide which parts of the history information and user attribute information to include in the prompt sentence. The server ranks candidate context items based on factors such as recency, relevance to the current inquiry type, and length constraints. The server then selects a subset of context items and incorporates them into the prompt sentence in a predefined order. This non-conventional, rule-based prompt-construction mechanism improves the quality and consistency of the model output by ensuring that the input token sequence captures important, structured context while remaining within the sequence length constraints of the generative AI model.

The server improves computer technology in several respects. The server reduces overall processing latency by centralizing tokenization, model input preparation, and decoding in a single processing pipeline that is tightly integrated with the parallel arithmetic device. The server eliminates redundant parsing and formatting that would occur if these operations were scattered across multiple independent services. By representing prompt sentences and history information in unified data structures and minimizing memory copies between components, the server reduces overhead and improves throughput when handling many concurrent user sessions.

The server improves resource utilization by scheduling model execution in batches and by sharing the same generative AI model and tokenizer across multiple requests. The server maintains queues of token sequences and groups them into batches that can be processed simultaneously by the parallel arithmetic device. The server thereby increases utilization of the arithmetic units in the device and improves the number of completed inferences per unit time. This batching mechanism is coordinated with prompt construction and decoding so that user-visible latency remains low.

The server further improves the accuracy and reliability of solution information by systematically incorporating user attribute information, usage-history information, and inquiry-type information into the prompt sentence. Rather than relying only on the immediate inquiry, the server provides a structured, multi-part input representation that aligns with the transformer's attention mechanism. The model can thus attend to relevant context tokens and produce more consistent and individualized outputs. This context handling is executed according to predefined data structures and selection rules, and therefore constitutes a specific, technical way of harnessing the capabilities of the generative AI model.

The server uses the training dataset and loss function to adjust parameters of the transformer network in a way that improves the mapping from prompt sentence to solution information. The server tunes hyperparameters such as learning rate, batch size, number of attention heads, and layer depth. The server can also provide alternative embodiments, in which the generative AI model includes encoder-decoder architectures or mixtures of expert modules, as long as the model accepts token sequences derived from prompt sentences and outputs token sequences representing solution information.

The server can employ alternative tokenization schemes. In one embodiment, the server uses subword tokenization based on byte-pair encoding. In another embodiment, the server uses a unigram language model tokenizer. The server adapts the vocabulary and tokenization rules to the target language(s) of the inquiries, so that the mapping between prompt sentence and token sequence remains efficient and unambiguous.

The terminal can take various forms. In one embodiment, the terminal is a mobile communication device with a touch-sensitive display. In another embodiment, the terminal is a general-purpose computer executing a web browser. In a further embodiment, the terminal is a dedicated appliance with limited functionality that displays solution information on a simple screen. In each embodiment, the terminal executes a local program that sends inquiry information to the server and displays received solution information in a conversational format.

The user interacts with the system by entering natural-language text. The user may revise previous inquiries, ask follow-up questions, or refer explicitly to earlier solutions shown on the conversational screen. The user thereby influences the content of the prompt sentences indirectly through the history information and inquiry-type information managed by the server.

By tightly coupling the server's prompt-sentence construction, tokenization, and execution of the generative AI model with the terminal's handling of conversational history, the system operates in a coordinated manner that is not a simple automation of human reasoning. Instead, the system uses specific data structures, neural-network computations, and communication protocols to implement a technical solution that improves speed, scalability, and precision of generating solution information. The causality between the defined processing pipeline and the technical effects-such as reduced latency, improved throughput, controlled memory usage, and consistent handling of context-is inherent in the architectural design of the server and its integration with the parallel arithmetic device and the machine-learning software platform.

In alternative embodiments, the server may support multiple generative AI models of different sizes or domains and select among them based on inquiry-type information. The server can route token sequences to a smaller model for simple inquiries to reduce computation, and route token sequences to a larger model for complex inquiries requiring more context. The server may also dynamically adjust generation parameters based on measured latency or load conditions, thereby further optimizing computational efficiency and user-perceived responsiveness.

In all embodiments, the server, the terminal, and the user cooperate such that the system realizes a computer-implemented technique that improves the internal operation of the computing machinery used to process natural-language inquiries and to generate solution information via a generative AI model and a prompt sentence.

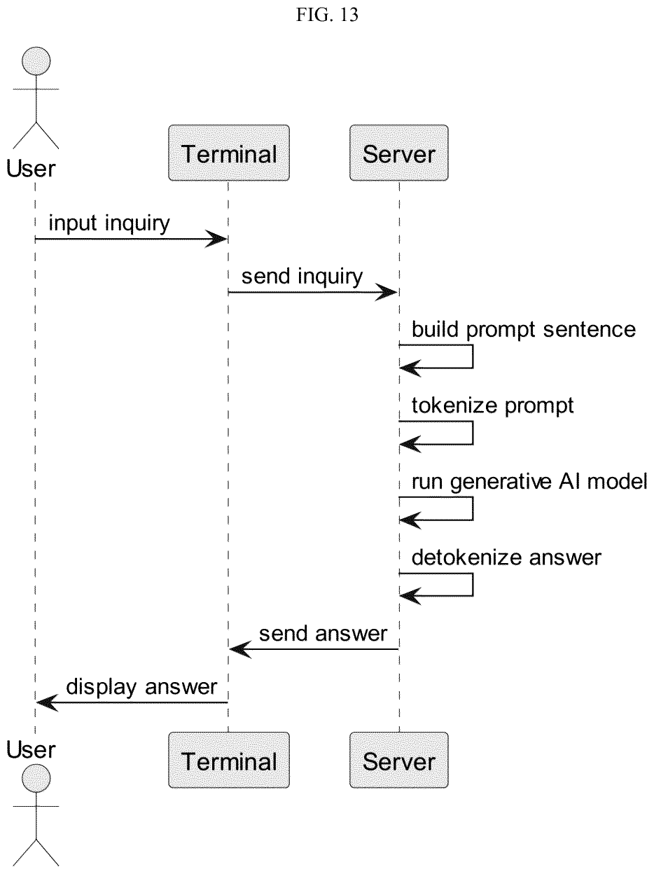

The following describes the processing flow using FIG. 13.

### Step 1

The user operates the terminal to input inquiry information in natural language. The user views a conversational screen on the terminal and types a question such as “My shoulders are very stiff. What can I do to relieve the stiffness?” into a text input field. The input is the user's keystrokes or touch events, and the output is a text string temporarily stored in the terminal's memory. The terminal converts the sequence of key events or touch inputs into a character string by using the operating system's input subsystem and stores the resulting UTF-8 encoded string as inquiry information.

### Step 2

The terminal constructs a request message containing the inquiry information. The input is the inquiry text string in the terminal's memory, and the output is a structured data object, such as a JSON object, ready for transmission. The terminal adds metadata including a session identifier, a user identifier (if available), a timestamp, and optionally a language code. The terminal serializes these fields into a text-based message using a data-serialization library and prepares an HTTP request with appropriate headers indicating content type and encoding.

### Step 3

The terminal transmits the request message to the server via a communication network. The input is the serialized request message and the server's network address, and the output is a network packet sequence sent over the network stack. The terminal invokes a network client component that encapsulates the message into one or more packets according to a transport protocol, and passes the packets to the network interface hardware. The terminal thereby converts local application data into a format suitable for network transmission and sends the data towards the server.

### Step 4

The server receives and parses the request message through its communication interface. The input is the sequence of network packets carrying the request, and the output is a reconstructed request object containing the inquiry information and metadata. The server's network stack reassembles the packets into a byte stream, verifies integrity (for example via checksums and protocol-level validations), and delivers the byte stream to the application layer. The server decodes the byte stream using a character encoding such as UTF-8 and parses the structured data format to extract the inquiry text and associated fields, storing them in main memory as internal variables.

### Step 5

The server performs basic validation and normalization of the inquiry information. The input is the raw inquiry text string and associated metadata, and the output is a cleaned inquiry string suitable for prompt construction. The server trims leading and trailing whitespace, normalizes line breaks to a standard representation, and rejects or flags inquiries that are empty or exceed a predetermined maximum length. The server may also standardize punctuation and remove non-printable characters. These operations are implemented as string-processing functions that scan the character sequence and produce a new, normalized string as output.

### Step 6

The server retrieves optional additional information for context. The input is the user identifier, session identifier, and inquiry-type indicators (if available), and the output is a set of structured records containing user attribute information, usage-history information, and inquiry-type information. The server queries a storage subsystem, such as a relational database or a key-value store, using the identifiers as keys. The server then obtains previous inquiries, past solution information, profile attributes, and category labels related to the current user and session. The server loads these data into memory as structured objects for subsequent use in prompt construction.

### Step 7

The server generates a prompt sentence by combining the normalized inquiry information with the additional information. The input is the normalized inquiry string and the structured context records, and the output is a single character string representing the prompt sentence. The server applies predefined rules to select relevant history entries and user attributes, orders them according to recency or relevance, and embeds them into a textual template. For example, the server may produce a prompt sentence such as “Previous interaction: You said that you often have stiff shoulders, and previous suggestions included stretching and using warm towels. Current question: My shoulders are very stiff. What can I do to relieve the stiffness?” The server thus performs string concatenation and templating operations to convert structured data into a coherent prompt sentence.

### Step 8

The server converts the prompt sentence into a token sequence using a tokenizer. The input is the prompt sentence character string, and the output is an ordered sequence of token identifiers represented as integers. The server invokes a tokenizer function that segments the prompt sentence into subword units according to a predefined vocabulary and mapping rules. The tokenizer scans the string, matches substrings against entries in the vocabulary, and replaces each recognized unit with its corresponding numeric identifier. The server stores the resulting token identifiers in an array or tensor data structure ready for numerical processing.

### Step 9

The server prepares the token sequence as input for the generative AI model and transfers it to the parallel arithmetic device. The input is the array of token identifiers in main memory, and the output is a tensor representing the token sequence stored in the memory of the parallel arithmetic device. The server converts the token array into a tensor of appropriate shape, for example [1, sequence_length], and casts it to the integer type required by the model. The server then invokes memory transfer routines provided by the machine-learning software platform to copy the tensor from host memory to device memory, taking into account alignment and batch configuration.

### Step 10

The server executes the generative AI model on the parallel arithmetic device to generate solution information. The input is the input token tensor and generation parameters such as maximum output length and sampling configuration, and the output is a generated token sequence representing the solution. The server instructs the machine-learning software platform to run the transformer network in inference mode. The parallel arithmetic device performs sequences of matrix multiplications, vector additions, and non-linear activations to compute layer outputs, attention weights, and probability distributions over the vocabulary. At each generation step, the server selects or samples the next token identifier based on the probability distribution and appends it to the output sequence, repeating this computation until an end condition is met.

### Step 11

The server decodes the generated token sequence back into character-string solution information. The input is the sequence of generated token identifiers, and the output is a text string containing the solution. The server invokes the tokenizer's decoding routine, which maps each token identifier to its corresponding text fragment and concatenates the fragments into a single string. The server post-processes the string by removing special control tokens, normalizing whitespace, and applying rule-based filters to eliminate unwanted repetitions or artifacts. The result is a human-readable sentence or paragraph describing suggested actions or advice for the user.

### Step 12

The server formats the solution information into a response message for the terminal. The input is the cleaned solution text string and metadata such as the session identifier and timestamp, and the output is a structured response object serialized for transmission. The server embeds the solution text into a response structure, adds status codes or flags indicating successful processing, and optionally includes the original prompt sentence and model information. The server then serializes this structure into a text-based message using a data-serialization library and prepares it as the body of an HTTP response with appropriate headers.

### Step 13

The server transmits the response message to the terminal over the communication network. The input is the serialized response message and the network connection parameters associated with the original request, and the output is a sequence of network packets carrying the response. The server's network stack segments the response into packets, assigns protocol headers, and sends the packets through the communication interface. The server thus converts internal response data into network-level signals that reach the terminal.

### Step 14

The terminal receives and parses the response message. The input is the sequence of network packets containing the response, and the output is the extracted solution text string and related metadata stored in the terminal's memory. The terminal's network stack reassembles the packets into a byte stream, verifies protocol-level correctness, and hands the stream to the application layer. The terminal decodes the byte stream into a character string and parses the structured format to obtain the solution information, the session identifier, and any additional fields. The terminal stores these values locally for display and for inclusion in history information.

### Step 15

The terminal updates the conversational user interface to present the solution information to the user. The input is the solution text string and existing conversation history stored on the terminal, and the output is an updated screen showing the new solution message. The terminal appends a new message element containing the solution text to an in-memory list representing the conversation log. The terminal then instructs the display subsystem to re-render the chat view, positioning the most recent message at the bottom and adjusting scroll position if necessary. The terminal may also apply styling rules to distinguish solution messages from user inquiries.

### Step 16

The terminal records the new interaction as history information. The input is the pair of inquiry information and solution information, together with timestamps and optional identifiers, and the output is a persistent record stored in a storage device. The terminal creates a structured record that associates the user's question, the server's answer, and the time of interaction. The terminal writes this record to non-volatile memory, such as a local database or file-based store, ensuring that it can later be retrieved and transmitted to the server as part of additional information for future prompt sentences.

### Step 17

The user reviews the solution information and optionally initiates a follow-up inquiry. The input is the solution text as displayed on the terminal screen, and the output is new inquiry information, if the user decides to continue the interaction. The user reads the advice, evaluates its relevance, and may enter another natural-language question, such as “How often should I stretch my shoulders during work?” into the same conversation interface. The terminal captures this new text and stores it as inquiry information, which then becomes the starting input for repeating the processing flow from the earlier steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional computer-implemented assistance systems, a processing device generally receives a user inquiry and returns either a fixed rule-based response or a generic output generated by a language model. Such systems typically treat each inquiry as an isolated text string and do not effectively utilize rich context, such as accumulated behavior history, dynamic location information, or current emotional state of the user. As a result, the responses are often generic, poorly targeted, and require substantial manual refinement by the user, which increases interaction latency and cognitive load.

Further, known systems that call a generative AI model usually pass a direct transformation of the user's message as a prompt, without a structured, context-aware prompt construction pipeline implemented by the server. In these configurations, the server behaves merely as a pass-through relay. This architecture fails to exploit server-side computational resources and stored data structures to shape the behavior of the generative AI model in a controlled and personalized manner. Consequently, the system cannot reliably steer the generative AI model toward organization-specific resources, cannot enforce per-user personalization at the prompt level, and cannot systematically adapt the model's tone and content in response to user state.

Moreover, existing personalization techniques in dialog systems are typically bound to recommendation engines operating on structured catalogs and do not deeply integrate with generative AI models through explicit prompt engineering logic implemented in the server. The server often lacks a unified representation of user context information that simultaneously includes behavior information, location information, and emotion information. Without such a unified context, the server cannot generate prompt sentences that simultaneously reflect user intent, long-term preferences, geographic constraints, and current emotional state. This leads to suboptimal utilization of the generative AI model's capabilities and may produce responses that are technically fluent but misaligned with the user's actual needs.

Additionally, there is a technical challenge in efficiently combining outputs of multiple analytical components-natural language processing, context aggregation, user profiling models, and organization-specific information resources-into a single control point for the generative AI model. Traditional architectures handle these components in a loosely coupled or ad-hoc manner, which results in higher processing latency, duplicated data transformations, and difficulty in enforcing global policies (for example, safety policies or corporate guidelines) at the time of prompt generation. Without an integrated server-side mechanism to construct context-rich prompt sentences, system performance in terms of response quality, relevance, and controllability remains limited.

Accordingly, there is a need for a computer-implemented system in which a server-side processor is improved to (i) construct and maintain unified user context information including behavior information, location information, and emotion information, (ii) perform natural language processing on user inquiries to extract intent and features, and (iii) algorithmically generate prompt sentences to be input to a generative AI model, such that the generative AI model is technically steered to produce context-aware, personalized, and organization-constrained solutions. There is also a need for the server to post-process the generated solution information in cooperation with information resources held by an organization and to format the solution in a manner optimized for a user interface, thereby improving the overall functioning of the computer system rather than merely automating a human mental process.

The specific processing by the specific processing unit 290 of the data processing device 12 in Application Example 2 is realized by the following means.

The present invention provides a server comprising a processor configured to receive inquiry information of a user via a communication application executed on a user terminal, acquire user context information including behavior information, location information, and emotion information associated with the user from one or more storage resources, perform natural language processing on the inquiry information to extract intent information and feature information, generate, based on the user context information and the intent information, a prompt sentence in natural language to be input to a generative AI model and to instruct the generative AI model to generate solution information, obtain the solution information from the generative AI model, select or narrow down candidate items based on an information resource held by an organization, and format the solution information into a form suitable for a user interface, and transmit the formatted solution information to the user terminal via the communication application so that the formatted solution information is presented to the user. This enables the processor to technically control the behavior of the generative AI model through context-aware prompt sentence generation, to integrate heterogeneous contextual data into a unified computational pipeline, and to improve the overall computer system by producing more relevant, personalized, and organization-constrained solutions with reduced processing redundancy and improved response quality.

The term “processor” refers to a hardware or virtual processing component, such as a central processing unit or execution core, that executes instructions to perform data processing operations defined by program code.

The term “user terminal” refers to an information processing apparatus operated by a user, such as a portable communication device, a desktop computing device, or a wearable device, that executes a communication application and presents information to the user.

The term “communication application” refers to a software component executed on the user terminal that enables exchange of information messages with the server, including text, audio, image, or other data, via a communication network.

The term “inquiry information” refers to data representing a request, question, or problem input by the user through the communication application, typically expressed as natural language text and optionally accompanied by additional input data.

The term “user context information” refers to information associated with the user and relevant to interpretation of the inquiry information, including behavior information, location information, emotion information, and other contextual attributes maintained by the server.

The term “behavior information” refers to data indicating past operations or activities of the user with respect to one or more services, including but not limited to access history, search history, purchase history, or usage history of applications.

The term “location information” refers to data indicating a geographic position related to the user terminal or the user, such as coordinates, region identifiers, or location labels obtained from a positioning mechanism or network information.

The term “emotion information” refers to data representing an estimated emotional state of the user, such as stress, fatigue, joy, anger, or sadness, derived by an emotion recognition process from user input or sensor data.

The term “natural language processing” refers to a computational technique for analyzing natural language data, including operations such as tokenization, parsing, semantic analysis, intent extraction, and entity recognition, performed by the processor.

The term “intent information” refers to data representing an inferred purpose or objective of the user's inquiry, derived from the inquiry information by natural language processing.

The term “feature information” refers to data representing extracted elements or attributes related to the inquiry information, including keywords, entities, constraints, or parameters relevant to generation of a solution.

The term “prompt sentence” refers to a textual instruction in natural language generated by the processor and provided as input to a generative AI model, the textual instruction specifying conditions, context, and requested behavior for generation of solution information.

The term “generative AI model” refers to a machine-learned computational model configured to generate natural language text or other content in response to a prompt sentence, based on statistical patterns learned from training data.

The term “solution information” refers to data generated by the generative AI model in response to the prompt sentence, the data including at least a proposed answer, recommendation, or guidance intended to address the user's inquiry.

The term “information resource” refers to a data holding mechanism, such as a data repository or database, maintained by an organization and storing information about services, products, or other items that can be referenced in generation or refinement of solution information.

The term “organization” refers to an entity that operates one or more services or manages one or more information resources, including a business entity, institution, group, or other structured body.

The term “candidate items” refers to elements, such as services, products, options, or content entries, selected or filtered from an information resource by the processor for possible inclusion in the solution presented to the user.

The term “user interface” refers to a presentation and interaction mechanism on the user terminal, including visual, auditory, or haptic elements, through which the user can receive solution information and perform input operations.

The term “data storage means” refers to one or more storage components, such as a memory device, database, or storage system, configured to store user context information, inquiry information, or other data used by the processor.

The term “location acquisition means” refers to a hardware or software mechanism configured to obtain location information, such as a positioning module, a network-based location service, or a sensor system associated with the user terminal.

The term “information retrieval means” refers to a functional component that acquires or searches information, such as a search interface, a retrieval engine, or a browsing subsystem, whose usage history can be recorded as behavior information.

The term “learning model” refers to a machine learning structure, such as a statistical model or neural network, trained on data to perform tasks including classification, regression, or pattern extraction, and used by the processor to analyze user context information.

The term “user profile” refers to a structured representation of user characteristics generated by the learning model, including preference information, behavior tendencies, and emotion-related tendencies derived from user context information.

The term “preference information” refers to data indicating a user's likes, dislikes, or tendencies regarding categories of services, products, or content, inferred from behavior information or explicitly provided by the user.

In one embodiment, a server includes a processor, a memory, a network interface, and a non-transitory storage medium storing instructions that, when executed by the processor, cause the server to implement the functions described below. The server communicates with one or more user terminals via a communication network. The user terminal includes a display device, an input device, optionally one or more sensors such as a positioning module, a microphone, or a camera, and executes a communication application that exchanges messages with the server.

The server executes an operating system and a server-side framework, for example a web framework implemented in a general-purpose programming language. The server further executes a natural language processing library, a machine learning framework, and one or more generative AI models deployed either locally or accessible via an external model-serving interface. The server also accesses one or more data storage systems, such as a relational data store or a document-oriented data store, that store user context information, information resources held by an organization, and log data.

The user terminal executes a communication application that provides a user interface for inputting inquiry information and displaying solution information. The communication application, which may be a native mobile application, a browser-based application, or a client of an enterprise communication platform, sends inquiry information to the server and receives solution information from the server. The user uses the terminal to input a natural language inquiry and optionally permits the terminal to provide location information or sensor data such as audio or images.

The server stores user context information in a structured format. In one embodiment, the server stores user context information in a document structure that includes fields such as a user identifier, a list of past inquiry records, a list of behavior events, a current location record, and a current emotion record. Each behavior event includes a timestamp, an event type identifier, and one or more feature values such as a category identifier or a numeric rating. Each location record includes latitude and longitude values, a region identifier, and an acquisition method identifier. Each emotion record includes an emotion label selected from a predefined label set and a confidence score represented as a numeric value.

The server uses a natural language processing pipeline implemented by the machine learning framework to analyze inquiry information received from the user terminal. The server performs tokenization, part-of-speech tagging, syntactic parsing, and named entity recognition on the inquiry information. The server computes a vector representation of the inquiry information, for example by applying a word embedding layer or a contextual embedding layer. The server applies an intent classification model implemented as a neural network that maps the vector representation to an intent label. The server also extracts feature information such as symptom terms, domain-specific entities, or constraint phrases by applying sequence labeling or pattern matching over the token sequence.

The server calculates emotion information by applying an emotion recognition process. When the user terminal transmits only text, the server executes a text-based emotion classifier implemented as a neural network. For example, the server uses a recurrent neural network or a transformer encoder with an output layer that predicts discrete emotion labels. The server computes an emotion score vector and selects the label with the highest score as the emotion label. When the user terminal transmits audio or image data, the server applies a model for acoustic emotion recognition or facial expression recognition. In such a case, the server may down-sample audio frames, compute spectral features, and input the features to a convolutional or recurrent neural network. The server may also convert image data into face feature maps and input the maps into a convolutional neural network. The server stores the resulting emotion label and score as part of the user context information.

The server constructs a user profile using a learning model trained on behavior information, location information, and emotion information. In one embodiment, the server uses a feedforward neural network with multiple hidden layers. The server defines input features that include counts or frequencies of event types, category usage statistics, location cluster identifiers, and emotion distribution vectors. The server normalizes numeric features and encodes categorical features using embeddings. The learning model processes these feature vectors and outputs a latent user embedding and one or more preference scores. The server stores the latent user embedding as part of the user profile and updates it over time as new behavior information is recorded.

The server generates a prompt sentence for a generative AI model by combining the intent information, the feature information, and the user profile with the current user context information. The server uses a rule-based template engine or a shallow neural generation model to assemble the prompt sentence. The server applies a set of prompt construction rules that map each intent label to a prompt skeleton. For example, for an intent corresponding to health-related general advice, the server constructs a skeleton that instructs the generative AI model to provide general self-care suggestions and to avoid diagnosis. The server then fills the skeleton with extracted symptom terms, emotion information, and relevant preference information.

The server, for example, generates a prompt sentence such as:

“The user says: ‘I have a headache.’ Provide general, non-medical self-care suggestions such as rest, hydration, and reducing screen time. Do not give a diagnosis or mention prescription medication.”

For a location-and preference-based restaurant query, the server generates a prompt sentence such as:

“The user is near a central urban station and usually prefers vegetarian food based on past behavior. Suggest several types of nearby vegetarian-friendly restaurants and describe what kind of dishes they typically serve. Do not include exact restaurant names or addresses.”

For an in-store relaxation product suggestion, the server generates a prompt sentence such as:

“Emotion analysis indicates that the customer feels tired and stressed. Suggest a few relaxing products suitable for a general lifestyle store, such as aroma candles, bath salts, or herbal teas, and briefly explain why each might help the customer relax.”

The server transmits the prompt sentence to a generative AI model. In one embodiment, the generative AI model is a transformer-based text generation model having multiple attention layers, feedforward layers, and layer normalization components. The generative AI model has been trained on a large corpus of text using an autoregressive objective that predicts the next token given previous tokens. The generative AI model maintains learned parameters such as weight matrices and bias vectors across the layers. During inference, the generative AI model receives the prompt sentence as an input token sequence, processes the token sequence through multiple attention and feedforward layers, and outputs a probability distribution over vocabulary tokens at each step. The generative AI model then generates output tokens by iterative sampling or greedy selection from these distributions.

The server obtains solution information from the generative AI model as a sequence of text tokens that form a natural language solution. The server decodes the tokens into text and then performs post-processing. The server segments the solution information into structured elements such as a body text, a list of recommendations, and optionally a set of bullet items. The server applies a policy filter to remove or modify segments that violate predefined constraints. The server may also parse the solution information to identify category-level suggestions, and then align these suggestions with concrete items from information resources held by an organization.

The server accesses information resources stored in data storage systems. These information resources may include tabular records describing services, products, or entities along with attributes such as category identifiers, geographic coverage, price ranges, and availability flags. The server executes queries that filter these records based on elements extracted from the solution information. For instance, when the generative AI model suggests “lavender aroma candle” as a relaxation product, the server searches the product data store for all items tagged with a category identifier corresponding to aroma candles and a feature attribute corresponding to lavender scent. The server ranks candidate items using relevance scores based on similarity between item descriptions and generated phrases, inventory status, or organizational priority. The server then selects top-ranked candidate items to be presented to the user.

The server formats the solution information and candidate items into a structure optimized for the user interface on the user terminal. In one embodiment, the server constructs a data object with fields that specify an explanation text, a list of recommendation entries, and metadata for each entry. Each recommendation entry contains an item identifier, a title text, a short description, an image reference, and an action hint such as a link or a command to open a map or start an order process. The server includes presentation instructions in the data object, such as recommended layout types and grouping information, so that the user terminal can render the content efficiently.

The user terminal receives the formatted solution information and renders it through a graphical user interface. The user terminal displays the explanation text in a dialogue-style area and displays the recommendation items as selectable elements with titles, short descriptions, and optional thumbnails. The user interacts with the interface by scrolling, tapping, or selecting items. When the user selects a recommendation, the user terminal may trigger additional actions such as opening a navigation application, launching a purchase flow, or sending a follow-up message to the server.

The server thereby improves computer technology by implementing a unified pipeline that tightly couples natural language processing, context modeling, prompt sentence construction, and organization-specific post-processing. The server reduces processing redundancy by representing user context information in standardized feature vectors and by reusing the user profile embedding across multiple inquiries. The server improves the accuracy and relevance of generated solutions by supplying the generative AI model with prompt sentences that incorporate structured context and policy constraints, rather than passing raw inquiries directly. This leads to fewer unnecessary model calls, reduced need for re-generation, and lower network and computational load.

The server further improves processing speed by precomputing and caching user profiles and by applying efficient feature extraction pipelines. For example, the server may maintain a cache of user embeddings in a memory-based store and update them incrementally as new events arrive, rather than recomputing the entire profile from scratch. The server reduces latency by performing feature encoding and prompt sentence construction with relatively shallow models and rule-based templates that are computationally lighter than full generative models, leaving the heavyweight text generation to a dedicated generative AI model.

The server enhances system robustness by enforcing non-conventional, technical rules at the prompt construction stage. These rules include explicit instructions about what the generative AI model must not output, such as disallowed types of medical advice, or instructions to avoid exact physical addresses. Because the server transforms raw inquiry information and user context into a constrained prompt sentence, the server guides the generative AI model into a restricted output space. This technical control mechanism differs from conventional human-in-the-loop editing, as the server performs automatic, rules-based transformation and selection of contextual features in a way that is not feasible for a human operator in real time.

The server also uses specialized data structures and algorithms for managing user context information and organization resources. In one embodiment, the server uses an index structure to map category identifiers and feature tags to sets of items in the organization's resources. The server applies efficient retrieval and ranking algorithms that combine similarity scores derived from vector embeddings with rule-based filters. Such a combination yields a technically improved selection mechanism that exploits the semantic richness of generative outputs while maintaining alignment with structured organizational data.

The server constructs the learning models used for user profiling and emotion analysis using a training process. The server defines an objective function such as a cross-entropy loss over predicted categories or a mean squared error over predicted scores. During training, the server updates model parameters using gradient-based optimization algorithms such as stochastic gradient descent or its variants. The server may perform data augmentation on text samples by paraphrasing or perturbing input phrases to improve model robustness. The server may also cluster location records or behavior events into higher-level features to reduce dimensionality and computation. As a result, the models learned by the server are tuned to the specific distributions of user behavior, location patterns, and emotion expressions present in the system's operational environment.

The user benefits from a system that delivers personalized and context-aware solutions without requiring explicit manual specification of all relevant constraints. The user simply inputs an inquiry through the user terminal, and the server applies the described technical mechanisms to generate a prompt sentence and to obtain and refine solution information from the generative AI model. The user thereby receives solutions that are adapted to the user's current context, including behavior information, location information, and emotion information, while the server ensures that the generative AI model operates within technically enforced boundaries and integrates with real-world resources.

In another embodiment, the server deploys multiple generative AI models or different versions of a generative AI model. The server selects a specific model based on the intent information or the type of organization resource being used. For instance, the server may route health-related prompts to a model fine-tuned for safe general wellness content, and route product recommendation prompts to a model fine-tuned on product description data. The server manages this routing via a configuration module that maps intent labels to model identifiers. This configuration enables the server to balance accuracy, safety, and computational cost across different types of tasks.

In yet another embodiment, the user terminal takes the form of a wearable device equipped with a display and sensors. The user terminal sends real-time sensor streams to the server, and the server quickly computes emotion information and context features, constructs prompt sentences, and returns compressed solution information suitable for low-bandwidth links. The server may compress data or adjust the level of detail based on network conditions, thereby reducing communication load while maintaining useful guidance. By implementing such adaptive behavior, the system not only automates information presentation but also optimizes data flow and computation at the system level.

Through the above configurations, the server, the terminal, and the user cooperate in a technical framework in which the server's construction of prompt sentences for a generative AI model, based on unified user context information and organization resources, results in improved speed, precision, and controllability of computer-based assistance compared to conventional architectures that lack such integrated context modeling and prompt engineering.

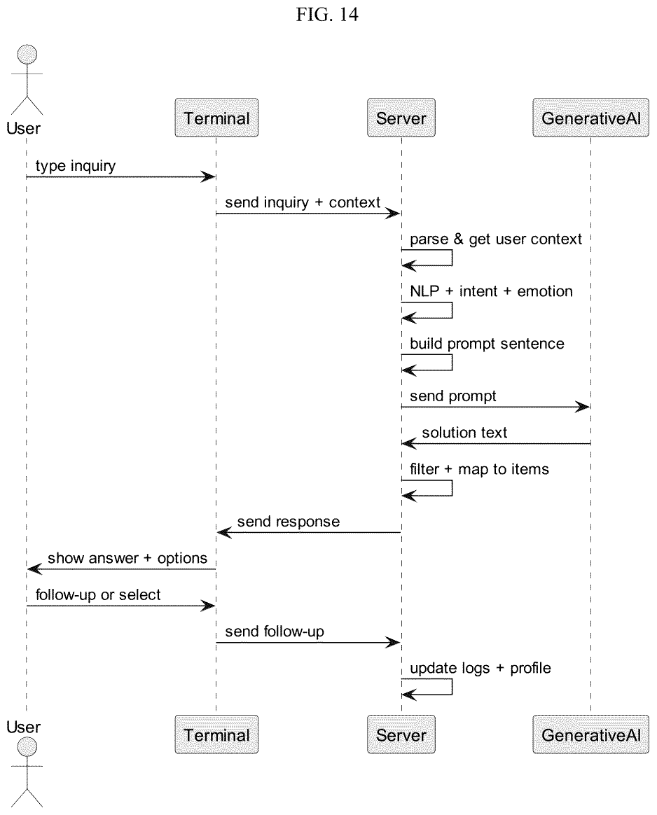

The following describes the processing flow using FIG. 14.

### Step 1

The user operates the terminal to input inquiry information.

The user launches the communication application on the terminal and enters a natural language message, such as “I have a headache”, “Where should I eat near here?”, or “I feel very stressed lately”, into an input field. The user optionally permits the terminal to access sensors such as a location acquisition function, a microphone, or a camera.

Input: user's natural language text (and optionally sensor permissions).

Output: inquiry information displayed in the terminal UI and ready to be transmitted.

### Step 2

The terminal sends the inquiry information and context information to the server.

The terminal packages the user's text, a user identifier, current time, and optional context (for example, GPS coordinates from a positioning module, language settings, and optionally audio or image data) into a structured message. The terminal uses a communication protocol (for example, HTTPS) to transmit this structured message to an endpoint of the server. If the transmission fails, the terminal retries or shows an error message.

Input: user's text, user identifier, local sensor readings, device settings.

Output: a network request containing consolidated inquiry information and context sent to the server.

### Step 3

The server receives and parses the incoming request.

The server accepts the network request through a network interface and passes it to a web framework module. The server parses the structured message to extract the user identifier, the inquiry text, timestamps, and any attached sensor data. The server records a log entry with a timestamp and a summary of the inquiry, and stores the raw request data in a data storage resource for traceability.

Input: structured message from the terminal.

Output: internal data objects representing inquiry text, metadata, and raw context stored in memory and log storage.

### Step 4

The server retrieves and updates user context information.

The server queries a data storage means using the user identifier to retrieve existing user context information, including behavior information, past inquiries, location history, and previously stored emotion information. The server merges the retrieved records with the new request data to create an updated user context object. The server may remove obsolete entries or aggregate older events into summary statistics to reduce data volume.

Input: user identifier, stored user context records, current request data.

Output: an updated user context object containing behavior, location, and emotion history, stored in memory.

### Step 5

The server performs natural language processing on the inquiry text.

The server applies a natural language processing pipeline to the inquiry information. The server tokenizes the text into tokens, assigns part-of-speech tags, and performs syntactic parsing. The server detects named entities and domain-specific terms. The server then computes an embedding vector for the inquiry and inputs the vector to an intent classification model. The server obtains an intent label and extracts feature information such as keywords, symptom names, or requested object categories.

Input: raw inquiry text.

Output: intent information (intent label), feature information (keywords, entities, constraints), and an embedding representation.

### Step 6

The server estimates the user's emotional state.

The server determines whether emotion analysis is required for the current inquiry. If the inquiry is text-only, the server inputs the text to a text-based emotion classifier and computes emotion scores for each possible label. If the inquiry includes audio or image data, the server pre-processes the audio (for example, computing spectral features) or image (for example, extracting facial regions) and applies respective neural network models. The server selects an emotion label with a highest score and records the label and score as the current emotion information.

Input: inquiry text and optionally audio data or image data.

Output: emotion information including an emotion label and a confidence score, stored in the user context object.

### Step 7

The server computes a user profile using a learning model.

The server transforms behavior information, location information, and emotion information from the user context object into feature vectors. For example, the server calculates frequency counts for categories, clusters location points into region identifiers, and derives distribution statistics for emotion labels. The server feeds these feature vectors into a learning model to generate a user profile representation. The server obtains a latent user embedding and derived preference information, and updates the stored user profile with the new embedding.

Input: user context object (behavior events, location history, emotion history).

Output: user profile including a latent embedding and preference information.

### Step 8

The server determines relevant organization resources.

The server examines the intent information and feature information to identify which organization resources are relevant. The server issues structured queries to information resources, such as a database of services or products, using parameters derived from the user profile and feature information. The server retrieves candidate items that match categories or attributes, such as “vegetarian restaurants”, “relaxation products”, or “general wellness services”. The server may compute preliminary relevance scores based on category matches and proximity to the user's current location.

Input: intent information, feature information, user profile, and organization databases.

Output: a candidate item list with identifiers, categories, and basic attributes.

### Step 9

The server constructs a prompt sentence for a generative AI model.

The server selects a prompt template corresponding to the intent information. The server fills the template with elements from the feature information, user profile, emotion information, and candidate item categories. The server also inserts explicit instructions, including restrictions and style constraints, into the prompt template. The server assembles these elements into a coherent prompt sentence in natural language.

Input: intent information, feature information, user profile, emotion information, candidate item categories.

Output: a prompt sentence to be supplied to a generative AI model.

### Step 10

The server sends the prompt sentence to the generative AI model and receives solution information.

The server transmits the prompt sentence, along with optional system-level instructions, to the generative AI model through a model-serving interface. The generative AI model processes the prompt sentence and generates token outputs. The server receives the token sequence from the generative AI model and decodes the sequence into a text string. The server stores the raw solution information for possible later analysis.

Input: prompt sentence and model configuration parameters.

Output: solution information in natural language text form.

### Step 11

The server analyzes and filters the solution information.

The server examines the solution information to ensure that it respects predefined constraints. The server may perform keyword scanning, pattern matching, or rule evaluation to detect disallowed content. If necessary, the server edits or truncates segments of the solution information or flags the response for regeneration. The server may also identify structured elements, such as discrete suggestions or steps, by segmenting the text.

Input: raw solution information from the generative AI model.

Output: filtered and segmented solution information suitable for alignment with organization resources.

### Step 12

The server aligns the solution information with candidate items.

The server computes similarity scores between phrases extracted from the solution information and descriptions of candidate items from organization resources. The server, for example, computes text embeddings and applies distance measures or ranking functions. The server selects one or more top-ranked items for each recommendation segment in the solution information, and attaches item identifiers and attributes to the corresponding segments.

Input: segmented solution information and candidate item list.

Output: enriched solution information that includes mappings to specific items from organization resources.

### Step 13

The server formats the enriched solution information for the user interface.

The server creates a response structure that contains a main explanation text and a list of recommendation entries. For each entry, the server includes an item identifier, a title, a short description derived from the solution information or the item record, and optional metadata such as price or location. The server also includes hints for rendering, such as whether to display items as buttons, cards, or list elements.

Input: enriched solution information with linked items.

Output: a formatted response object suitable for display on the terminal.

### Step 14

The server sends the formatted response object to the terminal.

The server encapsulates the response object in a network response and transmits it via the same communication channel used to receive the inquiry. The server sets appropriate response headers and codes to indicate successful processing. The server may record performance metrics such as processing time and the number of retrieved items before returning the response.

Input: formatted response object.

Output: a network response carrying the solution information and UI instructions to the terminal.

### Step 15

The terminal receives and renders the solution information.

The terminal parses the response object received from the server. The terminal updates the communication application interface to display the main explanation text as part of the conversation. The terminal constructs UI components (for example, selectable cards or list items) for each recommendation entry and displays them with titles and descriptions. The terminal may trigger additional device functions, such as opening a map application when the user selects a location-related entry.

Input: network response from the server containing formatted solution information.

Output: visual and interactive elements displayed on the terminal's user interface.

### Step 16

The user reviews the solution and performs follow-up actions.

The user reads or listens to the explanation and inspects the recommended items displayed on the terminal. The user may tap on a recommendation to start an order, request navigation, or open details, or the user may input a follow-up question, such as “Only vegetarian options, please” or “What if the headache continues?”. These user actions generate new input events at the terminal.

Input: displayed explanation and recommendations, user's interaction.

Output: follow-up user input or selection events for further processing.

### Step 17

The terminal transmits follow-up input and updates to the server.

The terminal converts the user's follow-up interactions into a new structured message that includes the current conversation identifier, the new text input or selected item identifiers, and updated context such as refined preferences. The terminal sends this message to the server in the same manner as in the initial inquiry, thereby initiating another processing cycle.

Input: follow-up text or selection events, session identifier.

Output: a new network request to the server containing updated inquiry and context information.

### Step 18

The server updates logs and user context with the new interaction.

The server receives the follow-up request and records it in the log. The server updates behavior information by appending new events such as item selections or completed purchases. The server may adjust the user profile based on the new behavior, recalculating feature statistics or updating an embedding, and then stores the updated user context information for use in subsequent cycles.

Input: follow-up request data, existing user context and profile.

Output: updated logs and user context information stored in data storage, ready for the next processing iteration.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

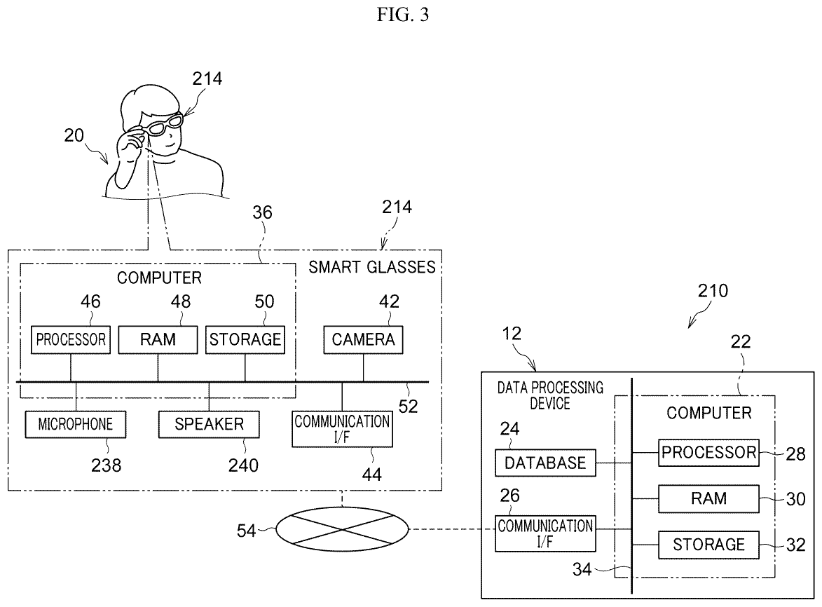

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

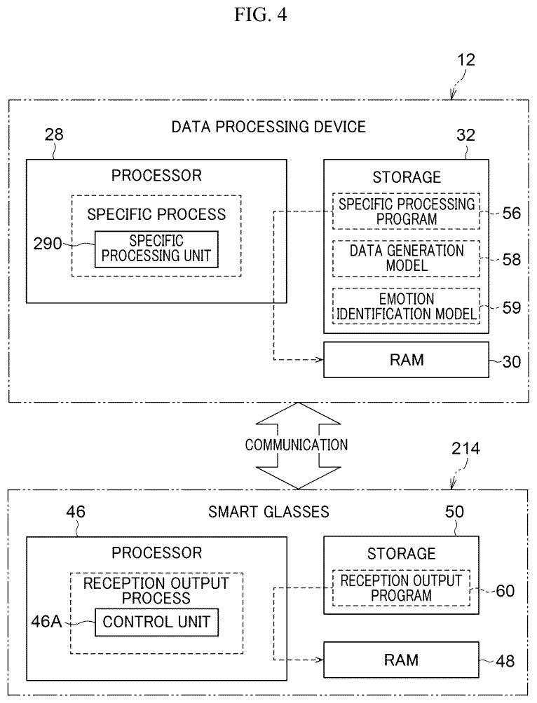

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

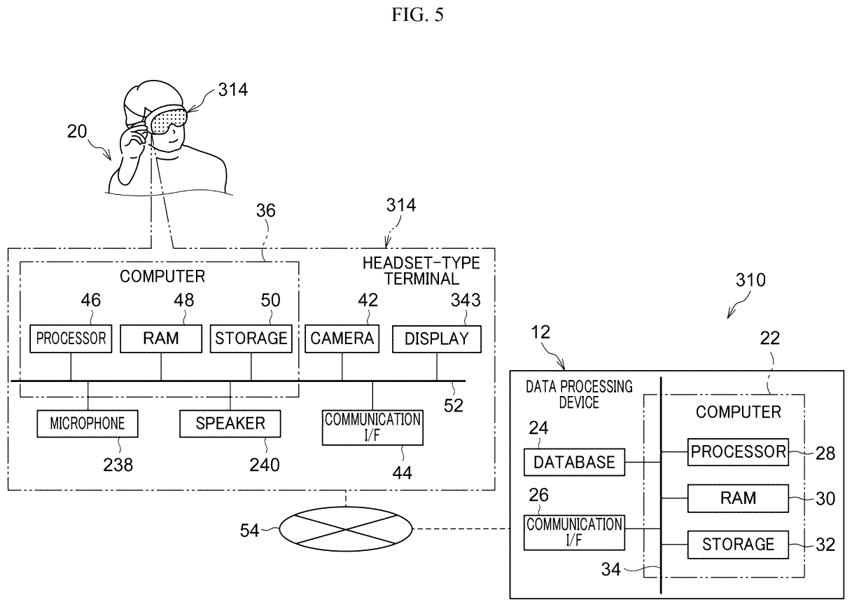

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

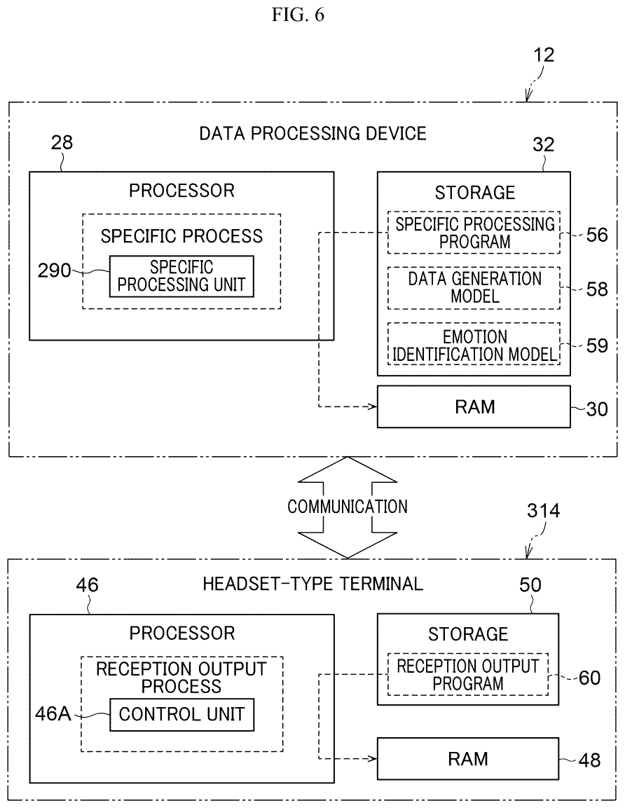

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

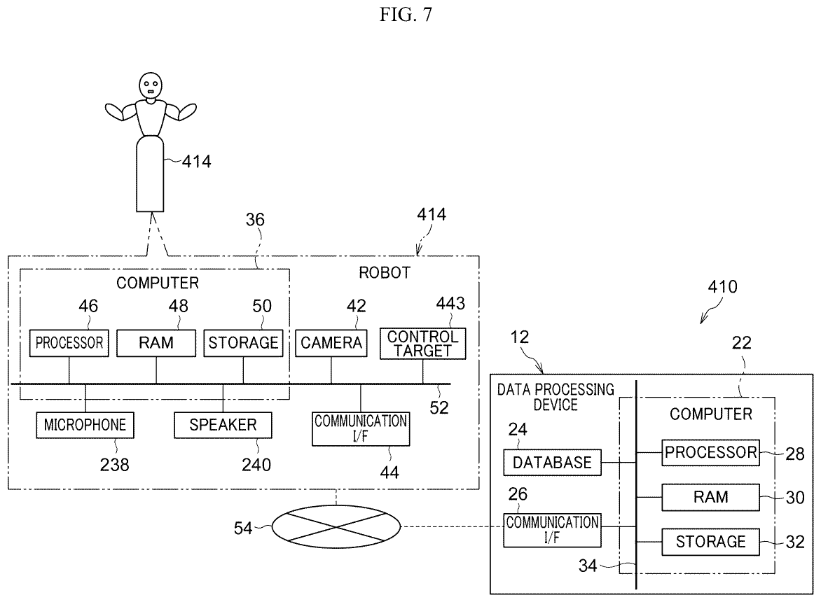

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

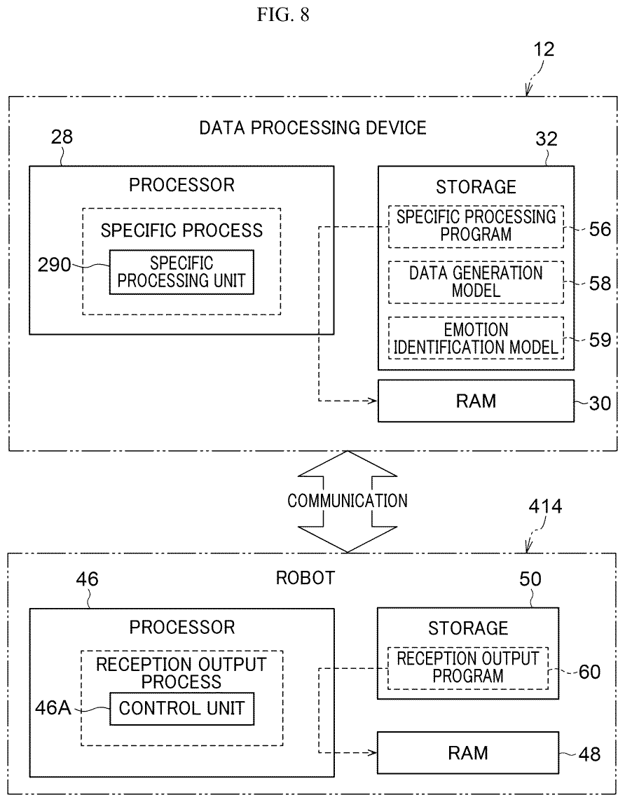

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

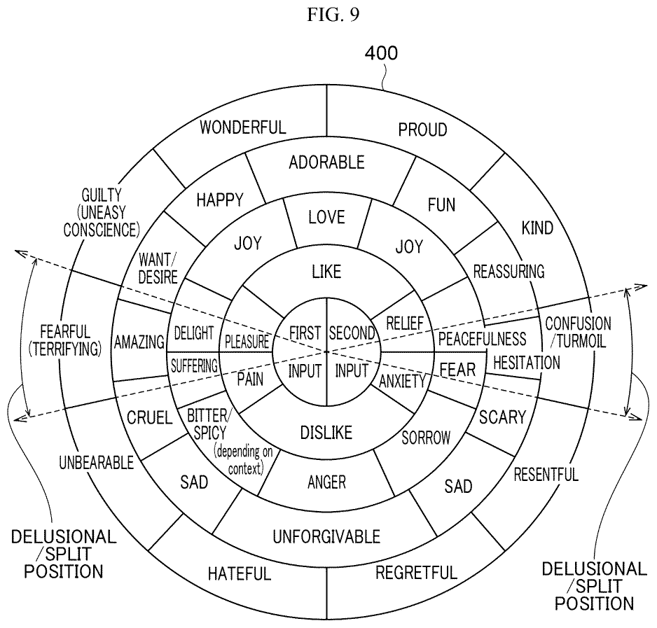

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

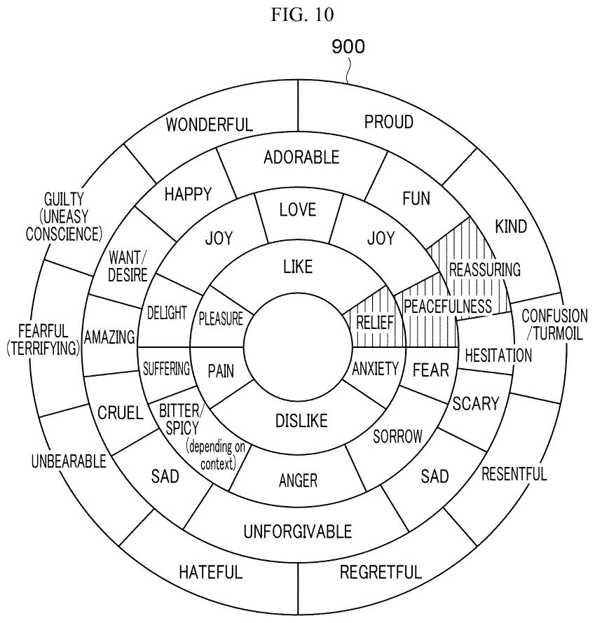

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive user information including inquiry information and location information from a terminal operated by a user,
analyze the received user information to determine an intention of the inquiry information, and generate a prompt sentence including the intention, the location information, and attribute information of information resources of an organization group, the prompt sentence being configured to instruct a generative AI model to generate search conditions or processing conditions, and output the prompt sentence to the generative AI model,
generate query data for searching the information resources of the organization group based on the search conditions or the processing conditions acquired from the generative AI model, search the information resources using the query data, and acquire candidate information, generate a prompt sentence for instructing the generative AI model to summarize or rank the candidate information based on the candidate information, and acquire personalized solution information from the generative AI model, and
transmit the acquired solution information to the terminal of the user and cause the terminal to present the solution information.

### Supplementary 2

The system according to supplementary 1,
wherein the processor is configured to
store support information including the location information and behavior history information acquired from the terminal of the user, and dynamically modify the prompt sentence to the generative AI model by including the support information in generation of the prompt sentence.

### Supplementary 3

The system according to supplementary 1,
wherein the processor is configured to
perform a computation on the candidate information using geospatial information stored in an information processing apparatus or an information management apparatus having a geographic information processing function, the computation being based on distance information, generate structured data reflecting a result of the computation, and include the structured data in the prompt sentence to the generative AI model so that the generative AI model generates response content for presenting, to the user, location-dependent personalized solution information.

### Application Example 1

### Supplementary 1

A system comprising a processor,
wherein the processor is configured to
receive, from a terminal over a network, information including an inquiry from a user, analyze the received inquiry as character information to extract an intention and a related target of the inquiry, and generate a prompt sentence suitable for interactive information generation processing by combining the inquiry with template information and context information,
convert the prompt sentence into a sequence of tokens, cause a generative AI model to execute an inference process by using the sequence of tokens as input, and generate solution information representing a solution corresponding to the inquiry,
extract attribute information and category information from the solution information, generate a search condition for performing a query process on an information set held by a business entity on the basis of the attribute information and the category information, and execute a search process on the information set on the basis of the search condition to acquire related information,
integrate the solution information and the related information to generate response information having a structure presentable to the user, and transmit and display the response information to the terminal via a user interface, and
store past inquiries and past solution information as a conversation history in a case of multiple interactions with the user, and generate the prompt sentence including the conversation history so as to cause generation of solution information consistent with multi-turn dialogue.

### Supplementary 2

The system according to supplementary 1,
wherein the processor is configured to
acquire past use history information and location information of an information acquisition device of the user for generation of the prompt sentence, and supplementarily construct the prompt sentence by adding the past use history information and the location information to the template information and the context information.

### Supplementary 3

The system according to supplementary 1,
wherein the processor is configured to
include past behavior history information and preference information of the user in the prompt sentence in the inference process by the generative AI model, and adjust the prompt sentence so as to cause generation of personalized solution information for the user.

### Example 2

### Supplementary 1

A system comprising a processor and a communication interface,
wherein the processor is configured to
receive, via the communication interface and over a communication network, inquiry information that has been input in natural language from a user terminal, convert the received inquiry information into structured character-string information as a prompt sentence, convert the prompt sentence into a token sequence conforming to an input format of a generative AI model,
input the token sequence into the generative AI model that is implemented by using a parallel arithmetic device and a machine-learning software platform, and cause the generative AI model to generate solution information corresponding to the inquiry information by performing numerical computation processing,
convert a token sequence output from the generative AI model into character-string information and format the character-string information as the solution information, and
transmit the formatted solution information as response data to the user terminal via the communication interface so that the solution information is displayed on a user interface of the user terminal.

### Supplementary 2

The system according to supplementary 1,
wherein the processor is configured to
cause the user terminal to present, on the user interface, a conversational screen that accepts input of the inquiry information and displays the solution information, to store the inquiry information and the solution information as history information in a storage device of the user terminal, and to transmit the history information to the processor via the communication network.

### Supplementary 3

The system according to supplementary 1,
wherein the processor is configured to
generate the prompt sentence by adding, to the inquiry information, at least one piece of additional information selected from attribute information of a user, usage-history information, and inquiry-type information, such that the generative AI model generates the solution information in accordance with an individual situation of the user.

### Application Example 2

### Supplementary 1

A system comprising a processor,
wherein the processor is configured to
receive inquiry information of a user via a communication application executed on a user terminal,
acquire user context information including behavior information, location information, and emotion information associated with the user,
perform natural language processing on the inquiry information to extract intent information and feature information,
generate, based on the user context information and the intent information, a prompt sentence in natural language to be input to a generative AI model and to instruct the generative AI model to generate a solution,
obtain solution information from the generative AI model, select or narrow down candidate items based on an information resource held by an organization, and format the solution information into a form suitable for a user interface, and
transmit the formatted solution information to the user terminal via the communication application so that the formatted solution information is presented to the user.

### Supplementary 2

The system according to supplementary 1,
wherein the processor is configured to
acquire, as the user context information, past use history information of an information retrieval means and location information obtained from a location acquisition means from a data storage means, and use the past use history information and the location information for generation of the prompt sentence.

### Supplementary 3

The system according to supplementary 1,
wherein the processor is configured to
generate a user profile by using a learning model that analyzes behavior history information, preference information, and emotion information included in the user context information, and adjust content and expression of the prompt sentence based on the user profile so that the generative AI model proposes a personalized solution.

What is claimed is:

1. A system comprising:
circuitry configured to:
receive, via a communication interface coupled to a packet-switched network, input data comprising character-string data from a terminal device operated by a first user;
perform an analysis operation on the character-string data to generate analysis result data;
construct, based on the analysis result data, a token sequence for input to a trained neural network model, and cause the trained neural network model to execute an inference operation on the token sequence to generate response candidate data;
transmit the response candidate data to a second terminal device via the communication interface; and
receive, from the second terminal device, correction data representing a modification to the response candidate data by a second user.

2. The system according to claim 1,
wherein the circuitry is further configured to:
select, from a template repository stored in a storage device, template data corresponding to an intent category derived from the analysis result data; and
construct the token sequence by combining the character-string data with the template data and context data.

3. The system according to claim 2,
wherein the context data comprises at least one of past interaction history data associated with the first user and attribute data associated with the second user.

4. The system according to claim 3,
wherein the circuitry is further configured to:
generate a plurality of pieces of response candidate data by varying at least one of decoding parameters and token sequence construction; and
compute, for each piece of response candidate data, a reliability index representing an estimated quality of the response candidate data.

5. The system according to claim 4,
wherein the circuitry selects, from the plurality of pieces of response candidate data, response candidate data to be transmitted to the second terminal device based on a ranking that combines the reliability index and an emotion state index derived from the analysis result data.

6. The system according to claim 5,
wherein the emotion state index is generated by performing an emotion analysis operation on the character-string data using an emotion classification model that outputs probability values for a plurality of emotion labels.

7. The system according to claim 1,
wherein the input data further comprises transaction data including payment information, and
wherein the circuitry is further configured to:
associate the response candidate data with the transaction data as screening input data; and
construct a primary-assessment token sequence comprising at least a portion of the transaction data.

8. The system according to claim 7,
wherein the circuitry is further configured to:
cause the trained neural network model to execute an inference operation on the primary-assessment token sequence to generate primary assessment result data indicating a risk classification of the transaction data.

9. The system according to claim 8,
wherein the circuitry is further configured to:
generate, based on the primary assessment result data and the transaction data, feature characterization data representing derived characteristics of the transaction data;
construct a final-assessment token sequence comprising the feature characterization data and the primary assessment result data; and
cause the trained neural network model to execute an inference operation on the final-assessment token sequence to generate final assessment result data.

10. The system according to claim 9,
wherein the circuitry is further configured to:
generate examination output data based on the final assessment result data, the examination output data comprising a classification code mapped from the final assessment result data; and
transmit the examination output data to the second terminal device via the communication interface.

11. The system according to claim 10,
wherein the feature characterization data comprises at least one of an anomaly score, a cross-border flag, and a high-amount flag derived by comparing the transaction data against statistical feature information computed from past transaction history associated with a user identifier.

12. The system according to claim 1,
wherein the circuitry is further configured to:
store the correction data and the response candidate data as history information; and
reflect the history information in subsequent construction of the token sequence to adjust output characteristics of the trained neural network model.

13. The system according to claim 12,
wherein the circuitry generates the token sequence to include at least a portion of the history information such that the response candidate data is consistent with multi-turn interaction between the first user and the second user.

14. The system according to claim 13,
wherein the circuitry is further configured to:
perform a semantic analysis operation on the character-string data to extract intent data and topic data; and
perform an emotion analysis operation on the character-string data to generate an emotion state index representing an estimated emotional state of the first user.

15. The system according to claim 14,
wherein the circuitry constructs the token sequence to include the emotion state index and the intent data such that the trained neural network model generates response candidate data adapted to the estimated emotional state of the first user.

16. The system according to claim 15,
wherein the response candidate data is generated such that the response candidate data comprises content estimated to increase a degree of reassurance and a degree of trust of the first user based on the emotion state index and the history information.

17. The system according to claim 16,
wherein the character-string data comprises content of a communication notebook transmitted from a guardian terminal device, the second terminal device is a teacher terminal device, and the second user is a teacher, and
wherein the response candidate data comprises a draft reply sentence to be presented to the teacher for modification before transmission to the guardian terminal device.

18. A system comprising:
circuitry configured to:
receive, via a communication interface coupled to a packet-switched network, input data comprising character-string data from a terminal device operated by a first user;
perform a semantic analysis operation and an emotion analysis operation on the character-string data to generate analysis result data comprising intent data, topic data, and an emotion state index;
select, from a template repository, template data corresponding to the intent data, and construct a token sequence by combining the character-string data, the analysis result data, the template data, and context data comprising past interaction history;
cause a transformer-based neural network model to execute an inference operation on the token sequence to generate a plurality of pieces of response candidate data, and compute a reliability index for each piece of response candidate data;
select, based on a ranking combining the reliability index and the emotion state index, response candidate data to transmit to a second terminal device via the communication interface;
receive, from the second terminal device, correction data representing a modification to the response candidate data by a second user; and
store the correction data, the response candidate data, and interaction outcome data as history information, and reflect the history information in subsequent construction of token sequences.

19. The system according to claim 18,
wherein the input data further comprises transaction data, and
wherein the circuitry is further configured to:
construct a primary-assessment token sequence comprising at least a portion of the transaction data, cause the transformer-based neural network model to generate primary assessment result data, generate feature characterization data based on the primary assessment result data and the transaction data, construct a final-assessment token sequence, cause the transformer-based neural network model to generate final assessment result data, and transmit examination output data based on the final assessment result data to the second terminal device.

20. A method performed by circuitry, the method comprising:
receiving, via a communication interface coupled to a packet-switched network, input data comprising character-string data from a terminal device operated by a first user;
performing an analysis operation on the character-string data to generate analysis result data;
constructing, based on the analysis result data, a token sequence for input to a trained neural network model, and causing the trained neural network model to execute an inference operation on the token sequence to generate response candidate data;
transmitting the response candidate data to a second terminal device via the communication interface; and
receiving, from the second terminal device, correction data representing a modification to the response candidate data by a second user.
